(19) United States
(12) Patent Application Publication
(10) Pub. No.: US 2026/0340077 A1
(43) Pub. Date: Oct. 29, 2026

(54) BIG-CLICK COSMOGENESIS SOLVER METHODS AND HARDWARE FOR PARAMETER FREE CMB SYNTHESIS VIA RECOGNITION PHYSICS FRACTIONAL DALEMBERTIAN EVOLUTION

(71) Applicant: Jonathan Washburn, Austin, TX (US)

(72) Inventor: Jonathan Washburn, Austin, TX (US)

(21) Appl. No.: 19/651,436

(22) Filed: Apr. 17, 2026

Related U.S. Application Data
(60) Provisional application No. 63/794,561, filed on Apr. 25, 2025.

(51) Int. Cl. G06F 17/17; G06F 17/14

(52) U.S. Cl. CPC G06F 17/17; G06F 17/142

(57) ABSTRACT

Methods, systems, and non-transitory computer-readable media are disclosed for parameter-free cosmic microwave background synthesis using a Big-Click cosmogenesis solver. A recognition-scale field is initialized on a lattice and evolved from an initial event at t=0 to a click time t_click using a fractional d'Alembertian operator. In representative embodiments, spatial processing is performed using FFT-based spectral operations and temporal processing is performed using fractional time integration, while a non-linear cost function is evaluated during field evolution. An evolved field is converted into photon-temperature perturbation data and into output observables including spherical-harmonic coefficients and angular power spectra. The disclosed embodiments may be implemented in software, GPU-accelerated systems, FPGA-accelerated systems, cloud-deployed systems, and non-transitory computer-readable media.

### CROSS-REFERENCE TO RELATED APPLICATIONS

This application claims the benefit of U.S. Provisional Patent Application No. 63/794,561, filed on Apr. 25, 2025, the entire disclosure of which is hereby incorporated by reference herein in its entirety to the extent permitted by law.

### BACKGROUND OF THE INVENTION

The present invention relates generally to numerical cosmology, scientific computing, and accelerator-based simulation, and more particularly to computer-implemented methods, systems, and hardware for generating cosmic microwave background outputs by evolving a recognition-scale field over a discrete lattice using a fractional d'Alembertian operator. More specifically, the invention concerns a Big-Click cosmogenesis solver configured to compute primordial perturbation behavior, generate radiation-transfer outputs, and produce spherical-harmonic coefficients and angular power spectra in software, GPU, FPGA, cluster, cloud, and hybrid-computing embodiments.

Conventional cosmological solvers generally rely on empirically fitted cosmological parameters, including the Hubble constant, baryon density, cold dark matter density, scalar spectral index, scalar amplitude, and optical depth, in order to generate output spectra that match observed cosmic microwave background data. Existing Boltzmann solvers and cosmological fitting pipelines may produce highly accurate output spectra, but typically do so by taking empirical parameter sets as inputs rather than by generating corresponding outputs from a fixed, parameter-free first-principles cosmogenesis engine. As a result, there remains a need for a deterministic solver that computes primordial perturbation behavior and downstream cosmic microwave background observables from a fixed operator structure without iterative fitting of conventional cosmological parameters.

There also remains a need for practical implementations of a fractional d'Alembertian operator, particularly implementations suitable for large three-dimensional lattices and compatible with FFT-based acceleration and fractional temporal integration. Although spectral and fractional methods are known in other computational contexts, prior systems have not provided a cosmogenesis solver that combines a recognition-scale field, a fractional d'Alembertian evolution operator, a non-linear cost-functional core, and a downstream cosmic microwave background output pipeline in a parameter-free architecture of the type disclosed herein. In particular, a need remains for a solver capable of evolving a recognition-scale field from an initial event at t=0 through a click interval defined by a fixed click-time structure and thereafter converting the evolved field into observable sky outputs, including spherical-harmonic coefficients and angular power spectra.

In the theoretical framework underlying the present disclosure, the cosmological initialization event is treated as a first recognition event, referred to herein as the Big Click. In that framework, the modeled evolution begins at t=0, and the interval from t=0 to t=t_click defines the primordial solver window for the disclosed numerical evolution. The broader framework may be referred to as Recognition Science, and in some materials as Recognition Physics; however, the present invention is directed to concrete computational methods, systems, and hardware for executing the disclosed solver architecture rather than to abstract theory alone. In this regard, the disclosed embodiments employ a recognition-scale field, a fractional d'Alembertian evolution path, and a non-linear cost functional in order to generate cosmic microwave background observables through an executable computational pipeline.

There further remains a need for hardware embodiments capable of executing such a solver efficiently, reproducibly, and at useful scale. Large-lattice cosmological evolution can impose substantial computational burdens, particularly where spectral transforms, time-history storage, and repeated non-linear evaluations are required. Accordingly, there is a further need for GPU and FPGA implementations capable of accelerating the disclosed solver, reducing wall-clock time, improving energy efficiency, and enabling practical validation workflows, including reference-spectrum comparison, seed-ensemble analysis, and resolution-convergence analysis.

Finally, there remains a need for a cosmogenesis platform that is not limited to a single output mode, but that can support alternative and downstream embodiments including polarization output, tensor-mode output, reionization modeling, low-l metric extraction, H0-related analysis, structure-formation export, cloud/API deployment, and educational visualization, while remaining grounded in a common solver architecture. The present invention addresses these and other needs through the methods, systems, hardware, and non-transitory computer-readable media disclosed herein.

### SUMMARY OF THE INVENTION

The present invention provides computer-implemented methods, systems, hardware architectures, and non-transitory computer-readable media for parameter-free cosmic microwave background synthesis using a Big-Click cosmogenesis solver. In representative embodiments, a recognition-scale field is initialized on a discrete lattice and evolved from an initial event at t=0 to a click time t_click using a fractional d'Alembertian evolution path. The solver is configured to generate primordial perturbation data, convert the evolved field into radiation-transfer outputs, and produce observable sky outputs including spherical-harmonic coefficients a_lm, angular power spectra C_l, map data, reports, and related cosmological observables. The disclosed subject matter may be embodied in software, GPU-accelerated systems, FPGA-accelerated systems, cloud-deployed systems, and hybrid computing environments.

In one aspect, the invention provides a computer-implemented cosmogenesis method in which a click time is defined, computed, received, or otherwise established for execution of a primordial evolution interval. In representative embodiments, the click time is defined according to the relation t_click=X_opt/c=(phi/pi)/c, where phi is the golden ratio, pi is the circular constant, X_opt is an optimization scale, and c is a propagation constant that may be represented in RS-native units as 1 voxel/tick. A recognition-scale field C_RP is initialized on a three-dimensional lattice, optionally around a cost minimum and with perturbations introduced according to a seed-controlled initialization process. The initialized field is then evolved from t=0 to t=t_click using a fractional d'Alembertian operator, after which the evolved field is processed to generate photon-temperature perturbation data and corresponding harmonic and spectral outputs.

In another aspect, the invention provides a solver architecture in which spatial evolution is performed using spectral processing and temporal evolution is performed using fractional integration. In representative embodiments, the field evolution is governed by Box\hat{ }(5/12) C_RP(x, t)=0, with a Fourier-space representation Box_hat\hat{ }(5/12)=(-omega\hat{ }2+|k|\hat{ }2)\hat{ }(5/12). The spatial portion of the operator may be implemented using a forward FFT of the lattice field, spectral-domain multiplication by a fractional spatial term including, in representative embodiments, |k|\hat{ }(5/6), and an inverse FFT to return the updated field to the spatial domain. The temporal portion of the evolution may be implemented using a fractional time-derivative path, including a Grunwald-Letnikov ladder and associated weight recursion, with time-history storage and stepped advancement over the click interval.

In another aspect, the invention provides a non-linear cost-functional core integrated into the cosmogenesis pipeline. In representative embodiments, the solver evaluates a cost function according to J_cost(X)=0.5*(X+1/X)−1=cosh(log(X))−1 at selected grid points, at all grid points, at selected times, at all times, or in other configured execution schedules. The non-linear cost-functional evaluation may be performed in floating-point or fixed-point arithmetic and may be implemented in software, on GPU devices, on FPGA devices, or in mixed computing environments. In representative embodiments, FPGA implementations may use piecewise-polynomial approximation, reciprocal evaluation logic, range guards, segment selection logic, coefficient storage, and pipelined fixed-point execution in order to reduce runtime and improve energy efficiency.

In another aspect, the invention provides output-generation methods and systems in which an evolved recognition-scale field is converted into observable cosmological outputs. In representative embodiments, the field at the end of the click interval is treated as a primordial perturbation field and supplied to a radiation-transfer stage configured to generate photon temperature perturbations along lines of sight. The resulting sky data may then be decomposed into spherical-harmonic coefficients according to DeltaT/T(n_hat)=sum_{l,m}a_lm*Y_lm(n_hat), and an angular power spectrum may be computed according to C_l=(1/(2*l+1))*sum_m |a_lm|\hat{ }2. Representative embodiments may use HEALPix or other sky discretization frameworks and may generate TT, TE, EE, and BB outputs, maps, metadata, and comparison reports.

In another aspect, the invention provides system embodiments comprising an initial-grid synthesizer, a click-time engine, a spectral fractional-operator module, a temporal integration module, a non-linear cost core, a radiation-transfer module, a spherical-harmonic decomposition module, an output store, a validation engine, and one or more processors and/or accelerators configured to execute the foregoing. The system may further include seed-management logic, checkpoint buffers, history buffers, scheduler logic, report-generation logic, provenance capture logic, and external interfaces for data export, validation, and downstream computational workflows. In some embodiments, the system is configured to perform deterministic execution for fixed seeds and fixed execution settings.

In another aspect, the invention provides GPU implementations of the disclosed solver. Representative embodiments may include one or more host processors, system memory, multi-GPU interconnects, GPU memory buffers, FFT library support, cost-kernel execution paths, and output aggregation logic. In another aspect, the invention provides FPGA implementations of the disclosed solver. Representative embodiments may include host interfaces, DMA engines, FFT engines, spectral multiplication logic, a fixed-point non-linear cost core, coefficient storage, reciprocal and guard logic, pipeline controllers, output DMA engines, and associated memory resources. The disclosed hardware embodiments enable execution of large-lattice simulations and may reduce wall-clock time and energy consumption relative to less-specialized implementations.

In another aspect, the invention provides non-transitory computer-readable media storing instructions that, when executed by one or more processors, GPUs, FPGAs, or other computing resources, cause the computing resources to perform the disclosed Big-Click cosmogenesis operations. Such media may store source code, executable code, accelerator-control logic, configuration files, output-generation scripts, validation scripts, map-generation scripts, API logic, reporting logic, and other instructions associated with execution of the disclosed solver architecture.

In another aspect, the invention provides validation and benchmarking workflows integrated with the solver architecture. Representative embodiments may compare generated C_l outputs against reference cosmic microwave background datasets, evaluate multipole ranges, compute residual statistics, extract peak positions, test low-l metrics, execute seed ensembles, test determinism, and perform resolution-convergence studies across multiple lattice sizes. The disclosed validation workflows may also be used to characterize hardware performance, runtime, memory use, and energy efficiency.

In another aspect, the invention provides optional and alternative embodiments including polarization computation, tensor-mode evolution, reionization modeling, gravitational-wave-related output generation, H0-related extraction workflows, low-l anomaly metric generation, downstream export of evolved fields for structure-formation workflows, cloud/API deployment, and educational or research visualization systems. These optional embodiments may share the same underlying click-time structure, fractional-operator evolution path, non-linear cost-functional core, and output-construction pipeline described herein.

In certain embodiments, the disclosed solver is framed within a broader Recognition Science or Recognition Physics context in which the cosmological initialization event is treated as a first recognition event, referred to herein as the Big Click, and the modeled primordial interval extends from t=0 to t=t_click. However, the present invention is directed to concrete computational methods, executable systems, hardware architectures, and machine-implemented workflows for performing the disclosed synthesis and output-generation operations. The invention therefore provides a practical computational architecture for parameter-free cosmic microwave background synthesis rather than a merely abstract theoretical statement.

### BRIEF DESCRIPTION OF THE DRAWINGS

FIG. 1 is a block diagram of an overall Big-Click cosmogenesis solver architecture showing representative functional components for click-time determination, lattice initialization, fractional-operator evolution, non-linear cost evaluation, radiation transfer, harmonic decomposition, validation, storage, and host interaction.

FIG. 2 is a timeline and state-evolution diagram showing a representative Big Click initialization and evolution interval extending from t=0 to t=t_click, including a cost-minimum initialization state, perturbation injection, fractional evolution, click-time completion, and downstream output branching.

FIG. 3 is a workflow diagram of lattice construction and initial perturbation synthesis showing representative spatial-domain definition, voxel-lattice generation, seed sourcing, perturbation scaling, initialized-field storage, optional boundary handling, and checkpointing operations.

FIG. 4 is a spectral-processing diagram for the spatial fractional operator showing representative input-field buffering, forward FFT processing, k-space representation, wavenumber generation, optional softening-scale input, spectral multiplication, inverse FFT processing, and output of a spatially updated field.

FIG. 5 is a temporal-integration and non-linear cost-core workflow showing representative current-state buffering, history buffering, fractional-weight generation, fractional-time derivative computation, non-linear cost evaluation, reciprocal handling, polynomial approximation, state combination, step counting, and termination checking.

FIG. 6 is an output-generation workflow for radiation transfer, spherical harmonic decomposition, and power-spectrum calculation showing representative evolved-field input, source-function generation, line-of-sight integration, sky-map generation, sky discretization, spherical harmonic decomposition, a_lm storage, C_l calculation, reference comparison, and report generation.

FIG. 7 is a representative multi-GPU implementation architecture showing a host processor, system memory, accelerator interconnect, multiple GPUs, FFT support, GPU cost-kernel execution, and output aggregation.

FIG. 8 is a representative FPGA implementation architecture including a fixed-point cost core and showing a host interface, DMA engines, FFT processing, spectral multiplication, coefficient storage, reciprocal and guard logic, pipeline control, external memory, and output transfer.

FIG. 9 is a validation and benchmark workflow showing representative simulation-output intake, TT comparison, TE/EE comparison, low-l metric extraction, seed-ensemble analysis, resolution-convergence analysis, reference-dataset access, residual calculation, acceptance criteria, and report output.

FIG. 10 is an alternative-embodiment architecture including representative scalar-mode, tensor-mode, polarization, reionization, higher-resolution, gravitational-wave, H0-extraction, structure-formation-export, cloud-API, and educational-visualization branches.

FIG. 11 is a downstream-analysis workflow for low-l metrics, H0 extraction, and structure-formation export showing representative low-l sky-map input, multipole extraction, alignment-angle calculation, S_1/2 calculation, asymmetry calculation, phi-resonance analysis, H0 and distance extraction, metric storage, and export functionality.

FIG. 12 is a representative computing and deployment environment showing one or more processors, one or more accelerators, memory, storage, a network interface, an instructions store, a solver engine, a validation engine, a provenance engine, and one or more user or external-system interfaces.

### DETAILED DESCRIPTION OF THE INVENTION

The following detailed description sets forth representative embodiments of the presently disclosed Big-Click cosmogenesis solver and associated methods, systems, hardware architectures, and non-transitory computer-readable media. It will be understood that the disclosed embodiments are illustrative rather than limiting, and that various modifications, substitutions, refinements, reorderings, and combinations may be made without departing from the scope of the invention as defined by the claims. Unless expressly stated otherwise, like terms are intended to carry like meaning throughout the specification, and the terminology introduced in this section is intended to provide clear written-description support and definitional support for the claimed subject matter. The disclosure is directed to executable computational architecture and associated hardware and software implementations for parameter-free cosmic microwave background synthesis, including but not limited to solver initialization, fractional-operator evolution, non-linear cost evaluation, radiation transfer, spherical-harmonic decomposition, validation, reporting, and downstream use.

As used herein, the term “Recognition Science” or “RS” refers to the broader theoretical framework within which the disclosed solver may be situated, and the term “Recognition Physics” may be used in some materials as an alternative name or framework label. In the present application, those terms are used only to the extent necessary to explain the computational origin, initialization structure, and operator framework of the disclosed solver, and are not intended to limit the invention to any purely theoretical formulation divorced from executable implementation. In particular, the presently disclosed subject matter is directed to concrete computational methods, machine-executable systems, accelerator implementations, and output-generation workflows for performing Big-Click cosmogenesis simulation and parameter-free cosmic microwave background synthesis.

In the Recognition Science framework, certain foundational concepts are cost-based and may be expressed using a cost functional of the form J(x)=0.5*(x+1/x)−1, which is mathematically equivalent to cosh(log(x))−1, and in this specification such a cost functional may be used as a non-linear cost core within representative solver embodiments. The Recognition Science framework also treats the cosmological initialization event as a first recognition event at t=0, and treats “before t=0” as outside the modeled ledger/time regime for purposes of executable simulation. However, unless expressly stated otherwise, specific solver choices disclosed herein—including particular click-time relations, particular fractional-operator exponents, particular spectral multipliers, particular discretization schemes, particular radiation-transfer machinery, and particular harmonic-decomposition or validation procedures—are disclosed as implementable embodiment choices of a cosmogenesis solver architecture and are not asserted to be the only possible Recognition Science-consistent implementations.

As used herein, the term “Big Click” refers to a cosmological initialization event modeled as a first recognition event. In representative embodiments, the modeled solver interval begins at t=0 and extends to a click time t_click, which defines a primordial evolution window during which a recognition-scale field is evolved according to a fractional d'Alembertian operator and associated non-linear cost-functional processing. In the framework used herein, “before t=0” is outside the modeled ledger/time regime and is therefore not part of the solver interval being numerically evolved. The Big Click is accordingly used in this specification as the computational initialization and temporal framing of the disclosed cosmogenesis pipeline.

As used herein, the symbol phi denotes the golden ratio, and may be represented as phi=(1+sqrt(5))/2. As used herein, the symbol pi denotes the circular constant. As used herein, the symbol X_opt denotes an optimization scale used in representative embodiments to define the click time according to t_click=X_opt/c, and in particular embodiments X_opt=phi/pi. As used herein, the symbol c denotes a propagation constant or characteristic propagation speed of the modeled system. In representative RS-native embodiments, c may be represented as 1 voxel/tick, although the invention is not limited to any single unit convention so long as the disclosed relationships and operations are preserved. As used herein, the symbol t_click denotes the click time terminating the primordial solver window, and in representative embodiments may be written as t_click=X_opt/c=(phi/pi)/c.

As used herein, the symbol tau_0 denotes an elementary or atomic tick scale used for optional mapping from RS-native units to SI display units. In representative embodiments, tau_0 may be related to conventional constants according to tau_0 =sqrt(hbar*G/(pi*c\hat{ }5)), and an SI-mapped click time may accordingly be represented as t_click_SI=X_opt*tau_0. Such SI mappings are provided for reporting, display, comparison, or presentation purposes and do not require that the solver itself be executed in SI units. The solver may instead operate in native units throughout execution and may optionally map outputs into SI or observational units at a later stage.

As used herein, the symbol C_RP denotes a recognition-scale field. The field C_RP may be scalar, tensor-valued, mode-decomposed, discretized, partially discretized, or otherwise represented according to the needs of a given embodiment. In representative embodiments, C_RP is initialized on a three-dimensional lattice and evolved during the click interval from t=0 to t=t_click. The field may be initialized around a cost minimum, around a nominal baseline state, around a normalized field state, or according to other suitable initialization procedures, and may include perturbations introduced via deterministic seed handling, stochastic generation, white-noise generation, bounded random generation, or related initialization techniques. In representative embodiments, the initial perturbation level may be approximately 10\hat{ }-5, although other perturbation magnitudes, perturbation spectra, or seed-conditioning approaches may be used.

As used herein, the term “lattice” refers to a discrete computational domain on which the recognition-scale field is represented and evolved. A lattice may comprise voxels, cells, nodes, memory-addressable elements, or other discretized spatial units. Representative lattice sizes include 512\hat{ }3, 1024\hat{ }3, 2048\hat{ }3, 4096\hat{ }3, and 8192\hat{ }3, although the invention is not limited to those sizes. The lattice may be embodied in contiguous memory, segmented memory, distributed memory, accelerator-local memory, host memory, or combinations thereof, and may be indexed according to Cartesian indexing, linearized indexing, tiled indexing, block indexing, or other suitable addressing schemes. The term “voxel” refers to a discrete volumetric lattice element and, in some native-unit embodiments, may be used in defining c=1 voxel/tick.

As used herein, the term “seed” refers to one or more values, states, or configuration inputs used to initialize perturbations, random-number generation, white-noise generation, pseudo-random sequences, or related initialization procedures. A seed may be fixed, selected, generated, user-provided, machine-generated, repeatable, cryptographically generated, or otherwise supplied. In representative deterministic embodiments, identical seeds and identical execution settings may produce identical outputs, thereby supporting determinism and reproducibility. Seed values, seed derivations, perturbation-generation settings, and related metadata may be stored in logs, checkpoint records, provenance bundles, validation reports, or other persistent records.

As used herein, the symbol Box denotes the d'Alembertian operator. The expression Box\hat{ }(5/12) denotes a fractional d'Alembertian operator of order 5/12. In representative embodiments, the field evolution is governed by Box\hat{ }(5/12) C_RP(x,t)=0. As used herein, the notation Box_hat\hat{ }(5/12) denotes a Fourier-space or spectral-domain representation of the fractional d'Alembertian operator, and in representative embodiments may be expressed as Box_hat\hat{ }(5/12)=(−omega\hat{ }2+|k|\hat{ }2)\hat{ }(5/12). The term “fractional” as used herein refers to non-integer operator order, non-integer differentiation, non-integer integration, or related operator behavior associated with the disclosed evolution path.

As used herein, the term “FFT” refers to a fast Fourier transform or an equivalent spectral transform used to move between spatial-domain and spectral-domain representations. A forward FFT may transform a discretized field into a spectral representation, and an inverse FFT may transform a spectral-domain representation back into a spatial-domain representation. The term “spectral multiplier” refers to one or more multiplicative terms applied in spectral space to implement all or part of the disclosed fractional spatial evolution. In representative embodiments, the spatial portion of the operator includes multiplication by |k|\hat{ }(5/6), where k denotes a wavevector or spatial-frequency quantity. In embodiments retaining an optional softening scale, an additional scale parameter such as k0=pi/phi may be incorporated into the spectral processing path, provided the numerical implementation of such scale usage is expressly disclosed.

As used herein, the term “temporal fractional integration” refers to a time-evolution path that uses a fractional derivative, a fractional integral, a Grunwald-Letnikov ladder, related weighted-history processing, or equivalent temporal-fractional mechanisms. In representative embodiments, the temporal path may be represented as d\hat{ }(5/6) C_RP/dt\hat{ }(5/6)~=(Delta t)\hat{ }(−5/6)*sum_{j=0}\hat{ }{n}w_j*C_RP(t-j*Delta t), with weights defined according to w_0=1 and w_j=w_{j−1}*(1−(5/6+1)/j). The terms “history buffer,” “weight generator,” and “time-history storage” refer to data structures and logic used to preserve prior time states and to support weighted fractional update operations. Representative embodiments may use Delta t=0.1*t_click and 10 time steps, although other step sizes, step counts, or adaptive schedules may be used.

As used herein, the symbol J_cost denotes a non-linear cost functional used in the disclosed evolution pipeline. In representative embodiments, J_cost(X)=0.5*(X+1/X)−1=cosh(log(X))−1. The cost functional may be evaluated at all grid points, at selected grid points, at all time steps, at selected time steps, or according to other configured schedules. The variable X supplied to J_cost may correspond to a field value, normalized field value, transformed field quantity, mode value, or related quantity depending on implementation. The term “cost core” refers to the software, firmware, logic, circuitry, accelerator kernel, or other execution structure used to evaluate J_cost. The cost core may include exact evaluation paths, approximate evaluation paths, reciprocal logic, range guards, polynomial approximation blocks, lookup structures, coefficient memory, segment selection logic, pipelined arithmetic, and associated support logic. In representative FPGA embodiments, the cost core may use 24-bit fixed-point arithmetic, 8 polynomial segments, and maximum approximation error less than 10\hat{ }-6, although other precisions, segmentation strategies, and error bounds may be used.

As used herein, the term “radiation-transfer stage” refers to processing that converts an evolved recognition-scale field into photon-temperature perturbation data, map data, harmonic coefficients, or related observable outputs. In representative embodiments, the radiation-transfer stage may use a line-of-sight computation according to DeltaT/T(n_hat)=integral S(tau, n_hat) d tau, where S denotes a source function and n_hat denotes a line-of-sight direction. Such processing may be internal to the disclosed system, may interface with other transfer machinery, or may combine internal and external modules. The term “last-scattering surface” refers to a modeled observational surface or effective radiative boundary used in generating observable sky outputs.

As used herein, the symbol a_lm denotes spherical-harmonic coefficients generated from sky data or map data. As used herein, the symbol C_l denotes an angular power spectrum quantity, which in representative embodiments may be computed according to C_l=(1/(2*l+1))*sum_m|a_lm|\hat{ }2. The term “spherical harmonic decomposition” refers to decomposition of sky data into spherical basis functions, and may include decomposition according to DeltaT/T (n_hat)=sum_{l,m}a_lm*Y_lm(n_hat). The term “map” refers to a sky representation, temperature-perturbation representation, polarization representation, or related structured observational output. Output data may include TT, TE, EE, and BB quantities, and may be stored in files, structured datasets, metadata bundles, report packages, or other persistent or transmissible forms.

As used herein, the term “HEALPix” refers to a hierarchical equal-area pixelization of the sphere, and the phrase “HEALPix or equivalent sky discretization” refers to that framework or any other discretization framework suitable for representing sky outputs and enabling spherical decomposition. Representative embodiments may use N_side=2048, although other resolutions may be used. The invention is not limited to a particular pixelization framework so long as the disclosed sky-generation and decomposition functionality is achieved.

As used herein, the terms “scalar mode,” “tensor mode,” “polarization mode,” “E-mode,” and “B-mode” refer to different perturbation, propagation, or output branches that may be included in optional embodiments of the disclosed solver. A scalar-mode embodiment may generate temperature-related primordial outputs, a tensor-mode embodiment may generate tensor-perturbation-related outputs, and polarization embodiments may generate E-mode and B-mode observables, cross-spectra, or associated report outputs. Such modes may share the same click-time framework, field-evolution architecture, non-linear cost-functional core, validation machinery, and hardware platform while differing in data path, transfer logic, output type, or branch-specific configuration.

As used herein, the term “validation” refers to any comparison, test, check, benchmark, convergence analysis, residual analysis, seed-ensemble analysis, runtime analysis, energy-efficiency analysis, reproducibility analysis, or related procedure used to characterize performance or output quality. A validation engine may compare generated C_l data with reference datasets, compute residuals, analyze multipole ranges, extract peak positions, compute low-l metrics, assess convergence across lattice sizes, or generate acceptance reports. The term “benchmark” refers to one or more representative runtime, efficiency, scale, residual, or output-comparison results used to characterize implementations. Any such benchmark values disclosed herein are representative embodiments and are not to be interpreted as limiting required thresholds unless expressly recited in a claim.

As used herein, the terms “GPU embodiment,” “FPGA embodiment,” “software embodiment,” “cloud embodiment,” and “hybrid embodiment” refer to different execution environments in which the disclosed solver may be implemented. A GPU embodiment may include one or more host processors, memory, GPU devices, GPU interconnects, FFT libraries, kernels, and aggregation logic. An FPGA embodiment may include host interfaces, DMA engines, FFT blocks, spectral multiplication logic, fixed-point cost-core circuitry, memory resources, and control logic. A software embodiment may be executed on one or more CPUs or general-purpose processors, and a hybrid embodiment may distribute different portions of the pipeline across CPUs, GPUs, FPGAs, cloud resources, or other accelerators. A cloud embodiment may expose APIs, job-queue infrastructure, storage services, and distributed execution controls.

As used herein, the phrase “non-transitory computer-readable medium” refers to any tangible medium capable of storing instructions for causing one or more processors or accelerators to perform the disclosed methods. Such media may include memory devices, storage devices, flash devices, solid-state storage, magnetic storage, optical storage, or other non-transitory media. Instructions stored thereon may include executable code, source code, firmware, configuration data, control logic, reporting scripts, validation scripts, API logic, data schemas, or related software materials.

As used herein, the term “provenance” refers to execution metadata, configuration history, formal-verification references, checkpoint data, seed data, lattice settings, benchmark settings, software versioning, hardware identifiers, and related records that may be associated with a run of the disclosed solver. A provenance engine may collect, store, and export such records for reproducibility, audit, validation, or research purposes. References to formal verification, theorem-proving artifacts, or architecture specifications are intended to support explanation and provenance of representative embodiments and are not intended to redefine the invention as being limited to a particular proof environment or codebase.

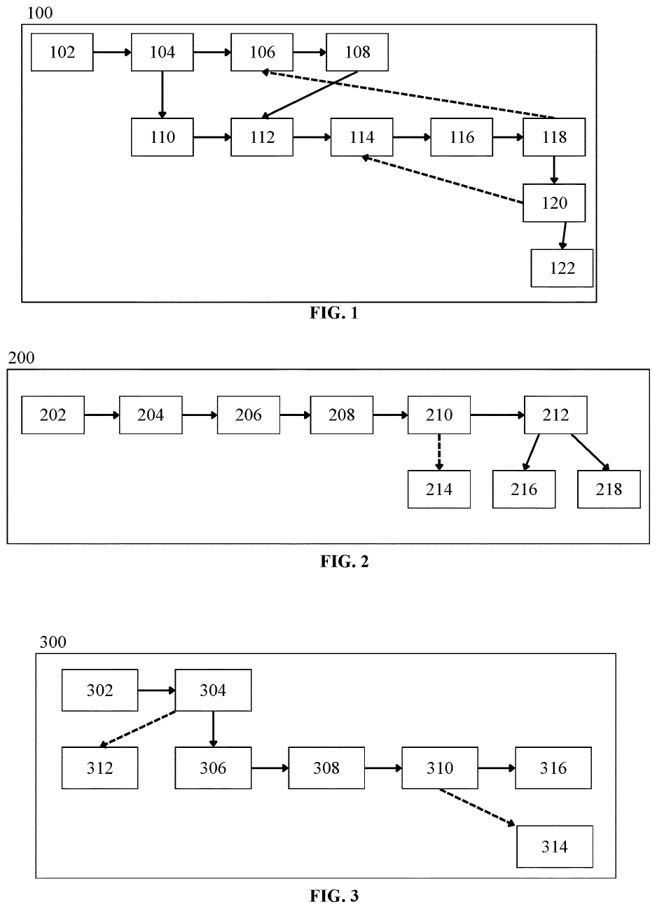

With the foregoing terminology established, the detailed description now turns to representative system architecture and representative figure-linked embodiments. In the discussion that follows, the drawings are described using the figure-based numeral scheme adopted for this application, in which FIG. 1 uses the 100 series, FIG. 2 uses the 200 series, FIG. 3 uses the 300 series, and so forth, with numerals increasing by increments of two within a given figure family.

This is the right opening for Detailed Description: it creates the definitions record, keeps everything in continuous narrative form, and sets up the numeral-bearing figure discussion.

With reference now to FIG. 1, a representative Big-Click cosmogenesis solver architecture 100 is shown. In the illustrated embodiment, the architecture 100 provides an integrated computational pipeline configured to determine or receive click-time parameters, generate an initialized recognition-scale field, execute fractional-operator evolution over a primordial interval extending from t=0 to t=t_click, evaluate a non-linear cost functional during that evolution, convert an evolved field into observable sky outputs, and generate validation, storage, and reporting products associated with the resulting simulation. Although FIG. 1 presents one representative arrangement of components, the functional blocks described herein may be combined, separated, reordered, distributed across multiple machines or accelerators, virtualized, containerized, or otherwise reconfigured without departing from the scope of the invention.

In the embodiment of FIG. 1, the architecture 100 includes an RS parameter store 102, a click-time engine 104, an initial grid synthesizer 106, a spectral fractional operator 108, a temporal integrator 110, a non-linear cost core 112, a radiation-transfer module 114, a harmonic decomposition module 116, an output store 118, a validation engine 120, and a host interface 122. In representative implementations, the RS parameter store 102 may retain one or more native-unit values, framework constants, solver constants, lattice settings, initialization settings, seed data, scaling selections, numerical-precision settings, checkpoint settings, output selections, and other configuration data used during execution of the solver architecture 100. The RS parameter store 102 may be embodied in local memory, distributed memory, accelerator-accessible memory, persistent storage, a configuration service, a structured file, a database, or any combination thereof.

The click-time engine 104 is configured to compute, derive, receive, or otherwise establish the click time used by the cosmogenesis pipeline. In representative embodiments, the click-time engine 104 determines t_click according to t_click=X_opt/c=(phi/pi)/c, where X_opt may be fixed, retrieved from the RS parameter store 102, or computed from one or more framework relations. In some embodiments, the click-time engine 104 may also compute or provide an SI-mapped representation of the click time according to t_click_SI=X_opt*tau_0, while in other embodiments the click-time engine 104 may maintain all timing in native solver units and defer any SI mapping until reporting or display stages. The click-time engine 104 may additionally provide derived quantities such as step size, number of time steps, scheduler boundaries, initialization timestamps, checkpoint intervals, or branch-trigger conditions used by downstream solver components.

The initial grid synthesizer 106 is configured to define the initial computational lattice and generate an initial recognition-scale field for subsequent evolution. In representative embodiments, the initial grid synthesizer 106 constructs a three-dimensional lattice of selected size, such as 512\hat{ }3, 1024\hat{ }3, 2048\hat{ }3, 4096\hat{ }3, or 8192\hat{ }3, allocates storage for an initialized field C_RP, selects or receives one or more seed values, and applies perturbations to a baseline field state. In some embodiments, the initial grid synthesizer 106 initializes the field around a cost minimum and introduces white-noise perturbations at approximately 10\hat{ }-5 amplitude, while in other embodiments the perturbation spectrum, amplitude range, seed structure, or normalization procedure may differ. The initial grid synthesizer 106 may also perform lattice partitioning, buffer preparation, memory tiling, domain decomposition, checkpoint initialization, and optional boundary-condition preparation for use during subsequent spectral and temporal processing. The spectral fractional operator 108 is configured to implement the spatial portion of the disclosed fractional d'Alembertian evolution path. In representative embodiments, the spectral fractional operator 108 receives field data from the initial grid synthesizer 106 or from an updated field state produced by later stages of the pipeline, performs a forward FFT to transform the field into a spectral-domain representation, applies one or more spectral multipliers corresponding to the spatial portion of the operator, and then performs an inverse FFT to return the resulting state to the spatial domain. In representative embodiments, the spectral multiplier includes |k|\hat{ }(5/6) to implement the spatial portion of Box^(5/12), while in optional embodiments an additional softening-scale parameter may be incorporated if expressly defined in the computational pathway. The spectral fractional operator 108 may be executed on CPUs, GPUs, FPGAs, or mixed accelerator resources and may use library-based FFT execution, custom FFT execution, streaming FFT logic, or other transform implementations.

The temporal integrator 110 is configured to implement the temporal portion of the field-evolution path and to advance the field through the click interval from t=0 to t=t_click. In representative embodiments, the temporal integrator 110 uses a fractional time-evolution structure including a Grunwald-Letnikov ladder with weighted time-history contributions. The temporal integrator 110 may therefore maintain one or more history buffers, compute or retrieve weights w_j, apply a relation of the form d\hat{ }(5/6) C_RP/dt\hat{ }(5/6)~=(Delta t)\hat{ }(−5/6)*sum_{j=0}\hat{ }{n}w_j*C_RP(t−j*Delta t), and update the current state according to a selected time-step schedule. In representative embodiments, the temporal integrator 110 operates with Delta t=0.1*t_click over 10 steps, although the architecture 100 is not limited to those values. The temporal integrator 110 may also coordinate scheduler state, termination conditions, checkpoint timing, variable-step control, and interaction with the non-linear cost core 112.

The non-linear cost core 112 is configured to evaluate the non-linear cost functional used in the disclosed solver. In representative embodiments, the non-linear cost core 112 evaluates J_cost(X)=0.5*(X+1/X)−1=cosh(log(X))−1 for field-derived values X at selected spatial locations, all spatial locations, selected time steps, or all time steps, depending on execution mode. The non-linear cost core 112 may receive current field values directly from the temporal integrator 110, from intermediate update buffers, or from transformed field quantities generated elsewhere in the architecture 100. In some embodiments, the non-linear cost core 112 performs exact floating-point evaluation; in some embodiments, it performs approximate or fixed-point evaluation; and in some embodiments, especially FPGA embodiments, it may employ piecewise-polynomial approximation, reciprocal logic, positivity or range guards, segment-selection logic, and pipelined arithmetic. The non-linear cost core 112 may therefore be one of the principal throughput-determining units of the architecture 100 and may be tightly coupled with accelerator-specific optimization logic.

The click-time engine 104, the initial grid synthesizer 106, the spectral fractional operator 108, the temporal integrator 110, and the non-linear cost core 112 may operate as a closed execution path during the primordial evolution interval. In one representative flow, the click-time engine 104 establishes t_click, the initial grid synthesizer 106 produces an initialized field state, the spectral fractional operator 108 performs a spatial-domain update in the spectral domain, the temporal integrator 110 performs a fractional temporal update, and the non-linear cost core 112 evaluates the cost-functional contribution for the updated state. This flow may repeat iteratively until the temporal integrator 110 determines that the click interval has completed. In some embodiments, the order of spatial updating, temporal updating, and cost-functional evaluation may be varied, interleaved, fused, or partially overlapped for performance reasons. In some embodiments, one or more of these blocks may be executed concurrently or in pipelined fashion across multiple processors or accelerator devices.

Once a field state corresponding to the end of the click interval has been obtained, the radiation-transfer module 114 is configured to transform or interpret the evolved field as a primordial perturbation field suitable for generation of observable sky outputs. In representative embodiments, the radiation-transfer module 114 executes or invokes line-of-sight source-function processing according to DeltaT/T(n_hat)=integral S(tau, n_hat)d tau, where S represents a source function and n_hat represents a line-of-sight direction. The radiation-transfer module 114 may be implemented internally within the solver architecture 100, may interface with external radiation-transfer machinery, or may combine internal and external components. The radiation-transfer module 114 may generate temperature perturbation data, polarization-related data, tensor-related data, intermediate source representations, sky maps, or other output structures for subsequent harmonic analysis.

The harmonic decomposition module 116 is configured to convert sky outputs produced by the radiation-transfer module 114 into harmonic and spectral representations. In representative embodiments, the harmonic decomposition module 116 performs spherical-harmonic decomposition according to DeltaT/T(n_hat)=sum_{l,m}a_lm*Y_lm(n_hat) and computes angular power spectra according to C_l=(1/(2*l+1))*sum_m|a_lm|\hat{ }2. The harmonic decomposition module 116 may operate on sky data represented in HEALPix or other discretization frameworks and may generate TT, TE, EE, and BB outputs depending on the mode structure of the embodiment. The harmonic decomposition module 116 may also generate transformed data products, multipole-limited outputs, band-limited outputs, peak-location outputs, comparison-ready data structures, and report-ready formatted results.

The output store 118 is configured to retain one or more categories of solver outputs and associated execution products. In representative embodiments, the output store 118 may retain evolved field states, sky maps, harmonic coefficients a_lm, angular power spectra C_l, validation bundles, benchmark reports, seeds, configuration records, provenance bundles, checkpoint files, logs, and export files for downstream analysis. The output store 118 may be implemented using local disks, network storage, object stores, memory-mapped storage, database systems, cloud storage services, or combinations thereof. In some embodiments, the output store 118 may retain multiple representations of the same execution, such as native-unit outputs, SI-mapped display outputs, validation outputs, reduced summary reports, and archival execution records.

The validation engine 120 is configured to evaluate the outputs of the solver architecture 100 against one or more reference criteria, benchmark criteria, or analysis workflows. In representative embodiments, the validation engine 120 compares generated C_l data against reference cosmic microwave background datasets, computes residuals across selected multipole ranges, extracts peak positions, evaluates low-l metrics, executes seed-ensemble comparisons, assesses determinism and reproducibility, and performs resolution-convergence studies. In some embodiments, the validation engine 120 may also assess hardware runtime, throughput, memory consumption, and energy efficiency. The validation engine 120 may generate acceptance reports, benchmark summaries, prosecution-support records, technical appendices, or machine-readable validation outputs suitable for research, audit, or productization workflows.

The host interface 122 is configured to permit user, programmatic, or external-system interaction with the architecture 100. In representative embodiments, the host interface 122 may accept configuration inputs, seeds, lattice selections, run commands, validation options, output selections, API requests, cloud job requests, or visualization requests. The host interface 122 may also return maps, spectra, coefficients, logs, reports, provenance bundles, and downstream-export artifacts. In some embodiments, the host interface 122 comprises a local user interface, a command-line interface, an API endpoint, a cloud-service interface, a scheduler interface, or a remote orchestration interface. The host interface 122 may also coordinate communications among the RS parameter store 102, the output store 118, the validation engine 120, and external consumers of solver data.

In operation, the architecture 100 may therefore be understood as an integrated execution framework in which click-time determination, lattice initialization, spatial fractional processing, temporal fractional processing, non-linear cost evaluation, observable-output generation, and validation are all linked within a common solver pipeline. Although FIG. 1 illustrates a monolithic functional arrangement for clarity, the architecture 100 may be decomposed into services, kernels, engines, hardware blocks, or distributed subsystems. For example, the spectral fractional operator 108 and the non-linear cost core 112 may be placed on one or more GPUs, the temporal integrator 110 may be coordinated by a host CPU, and the validation engine 120 may execute on separate compute resources after completion of the primary evolution. In other embodiments, the spectral fractional operator 108, temporal integrator 110, and non-linear cost core 112 may be fused into a single accelerator-oriented pipeline. In still other embodiments, the radiation-transfer module 114 and harmonic decomposition module 116 may be executed in separate stages after field evolution is completed and checkpointed.

The architecture 100 is not limited to embodiments that execute one complete field-evolution run from start to finish without interruption. In some embodiments, the architecture 100 may support checkpointing and restart, branch execution from stored intermediate states, multiple-seed batch execution, multi-resolution execution, validation-only reruns, partial-output generation, or downstream export of intermediate field states. Likewise, the architecture 100 is not limited to embodiments that produce only a single output category. Depending on configuration, the architecture 100 may generate primordial field outputs, temperature maps, polarization outputs, harmonic coefficients, power spectra, residual reports, low-l metric reports, H0-related outputs, structure-formation export bundles, cloud-service responses, educational visualizations, or combinations thereof.

Accordingly, FIG. 1 illustrates a representative top-level architecture 100 for performing the disclosed Big-Click cosmogenesis computation and associated output generation, while leaving flexibility for the specific implementation details, execution partitioning, hardware mapping, and deployment mode to vary across embodiments. The figure and the accompanying description therefore provide written-description support for the broad method, system, hardware, and non-transitory computer-readable medium aspects of the invention and form the basis for the more detailed figure-linked embodiments described below.

With reference now to FIG. 2, a representative Big-Click evolution timeline 200 is shown. In the illustrated embodiment, the timeline 200 includes an initial time state 202 corresponding to t=0, a cost-minimum initialization state 204, a perturbation-injection stage 206, a fractional-evolution interval 208, a click-time endpoint 210 corresponding to t=t_click, an evolved primordial field output 212, an optional SI bridge 214, a downstream branch 216, and a CMB-generation branch 218. FIG. 2 is provided to illustrate the temporal framing of the disclosed solver, the relation between native solver units and optional display/reporting units, and the sequence by which an initialized recognition-scale field is advanced through the Big Click interval and then provided to downstream computational stages.

In representative embodiments, the initial time state 202 marks the beginning of the modeled primordial interval. The present disclosure uses t=0 as the solver origin for the Big Click computation. In the framework used herein, the Big Click is the first recognition event and thus defines the earliest time state represented within the numerical solver. Accordingly, the timeline 200 begins at the initial time state 202 rather than attempting to model any prior ledger or pre-ledger interval. This use of t=0 is not merely a display convention, but rather serves as the computational starting point for initialization, scheduling, stepping, checkpointing, and downstream output timing throughout the disclosed architecture.

The cost-minimum initialization state 204 represents a baseline or starting state of the recognition-scale field prior to perturbation injection. In representative embodiments, the field is initialized at or around a cost minimum associated with a normalized baseline state. In such embodiments, the cost minimum provides a starting configuration from which perturbations can be introduced in a controlled manner. The cost-minimum initialization state 204 may therefore correspond to a field condition in which a baseline variable X is set to 1, a baseline cost is minimized, and the lattice is prepared for the addition of perturbative structure. In some embodiments, this initialization state may also include normalization, scaling, range checking, and buffer preparation steps executed prior to introduction of perturbations.

The perturbation-injection stage 206 represents the stage at which the initialized field receives perturbative structure for subsequent evolution. In representative embodiments, the perturbation-injection stage 206 introduces white-noise perturbations of approximately 10\hat{ }-5 amplitude into the initialized recognition-scale field. In other embodiments, the perturbation structure may be drawn from a bounded random process, a seeded pseudo-random process, a deterministic perturbation schedule, a structured mode initialization, or another perturbation-generation process suitable for creating a non-trivial initial field state. The perturbation-injection stage 206 may receive seed information from a seed-management module, from stored metadata, or from a host interface, and may record the applied seed or perturbation profile for later validation and reproducibility analysis.

The fractional-evolution interval 208 extends from the initial time state 202 to the click-time endpoint 210 and corresponds to the temporal interval over which the recognition-scale field is evolved according to the disclosed fractional-operator framework. In representative embodiments, the duration of the fractional-evolution interval 208 is defined by the click time t_click, which may be expressed as:

t_click=X_opt/c=(phi/pi)/c

where phi is the golden ratio, pi is the circular constant, X_opt is an optimization scale, and c is a propagation constant. In representative embodiments, X_opt=phi/pi, such that t_click is directly determined once c is specified in the chosen unit system. In some embodiments, c is represented in RS-native units as 1 voxel/tick, in which case t_click=X_opt in tick units. In other embodiments, c may be represented differently so long as the disclosed relationships are maintained. The click time therefore serves as the temporal boundary of the primordial solver window and defines the termination point for the corresponding fractional field evolution.

In representative native-unit embodiments, the propagation constant c is treated as 1 voxel/tick. Under that convention, the timeline 200 is expressed in solver-native units defined by lattice steps and time ticks rather than by externally imposed SI units. Native-unit execution may be advantageous because it permits the solver to operate directly in a normalized computational framework without repeated conversion into display or reporting units during intermediate stages of execution. In such embodiments, the click-time engine may determine t_click in ticks, the temporal integrator may schedule updates in tick-derived step sizes, and the output pipeline may preserve native-unit provenance until a later reporting stage. This native-unit architecture may reduce computational clutter, preserve exact internal relationships, and isolate reporting conversions from the core solver path.

In representative embodiments, a derived tick scale tau_0 may be used to map native solver timing into SI display units for external reporting or comparison. In one such embodiment, tau_0 is represented according to:

tau_0=sqrt(hbar*G/(pi*c\hat{ }5))

and the corresponding SI-mapped click time may be written as:

t_click_SI=X_opt*tau_0

Under this arrangement, the optional SI bridge 214 may receive one or more native-unit timing values and produce corresponding SI-display values suitable for inclusion in reports, validation documents, educational visualizations, or comparative analyses. The optional SI bridge 214 is therefore a reporting and representation layer rather than a required component of the fundamental solver logic. In many embodiments, the solver may execute entirely in native units and only later invoke the optional SI bridge 214 when generating a display or export product.

In representative embodiments, any mapping of solver-native units into SI-display units is treated as a reporting convention rather than as a fitted parameter of the solver. Accordingly, the solver may execute entirely in native units while SI-display values are generated only for presentation, logging, or comparison. Different mapping conventions may be used so long as the chosen convention is consistently recorded in provenance data associated with a run, and the disclosed invention is not limited to any single SI mapping identity.

The click-time endpoint 210 marks the temporal termination of the primordial evolution interval represented by the fractional-evolution interval 208. In representative embodiments, the temporal integrator determines that the click-time endpoint 210 has been reached when accumulated step advancement equals, reaches, or otherwise satisfies a selected numerical criterion for t_click. In some embodiments, the criterion may be exact equality in native units. In some embodiments, the criterion may be within a tolerance band around t_click. In some embodiments, the criterion may be associated with a final scheduled time step in a finite-step integration procedure. For example, in a representative embodiment using Delta t=0.1*t_click, the click-time endpoint 210 may be reached after 10 scheduled time steps. The click-time endpoint 210 may trigger field finalization, checkpoint generation, output export, downstream branching, validation activation, or any combination thereof.

The evolved primordial field output 212 represents the state of the recognition-scale field at the conclusion of the fractional-evolution interval 208. In representative embodiments, the evolved primordial field output 212 is treated as a primordial perturbation field suitable for downstream radiation-transfer processing and subsequent output generation. The evolved primordial field output 212 may be stored in a field buffer, a checkpoint file, a persistent datastore, or accelerator-accessible memory, and may be exported in full-resolution form, reduced form, transformed form, or branch-specific form depending on the intended downstream use. In some embodiments, the evolved primordial field output 212 may also be associated with provenance metadata including seed values, perturbation settings, lattice dimensions, execution precision, time-step schedule, and solver configuration data.

The optional SI bridge 214 may operate on the evolved primordial field output 212 or on associated timing, scaling, and report values. In representative embodiments, the optional SI bridge 214 converts timing values, display scales, or report quantities from native solver units into SI-compatible or observation-facing units. In some embodiments, the optional SI bridge 214 may produce a display-time representation of the click interval, a human-readable summary of scale relations, or an observational-comparison package that includes SI-labeled quantities for external presentation. In other embodiments, the optional SI bridge 214 may be bypassed entirely, particularly where the solver is being used in a native-unit research context or where downstream modules natively consume the produced field data without requiring unit relabeling.

The downstream branch 216 represents one or more computational branches that consume the evolved primordial field output 212 for later-stage analysis or simulation beyond the immediate CMB synthesis path. In representative embodiments, the downstream branch 216 may include structure-formation export, low-l metric extraction, H0-related analysis, tensor or polarization branching, reionization-stage extension, gravitational-wave-related analysis, educational visualization, cloud packaging, or external pipeline integration. In some embodiments, the downstream branch 216 may use the evolved primordial field output 212 directly. In some embodiments, the downstream branch 216 may operate on transformed, compressed, resampled, or mode-filtered versions of the evolved field. The downstream branch 216 thus represents the broader computational utility of the Big Click output beyond any single reporting mode.

The CMB-generation branch 218 represents the principal observable-output pathway in which the evolved primordial field output 212 is passed into radiation-transfer and harmonic-decomposition stages to generate photon-temperature perturbations, sky maps, spherical-harmonic coefficients, and angular power spectra. In representative embodiments, the CMB-generation branch 218 uses the evolved field as the source or precursor of the perturbation structure subsequently mapped into observable sky data. The CMB-generation branch 218 may include internal transfer machinery, interfaced transfer machinery, line-of-sight integration, sky discretization, harmonic decomposition, map generation, residual analysis, reference comparison, and report generation. Accordingly, the CMB-generation branch 218 is the principal path by which the solver converts the modeled primordial click interval into reference-comparable cosmological outputs.

The timeline 200 also illustrates that the Big Click interval is a bounded primordial computational window rather than an unbounded or indefinitely extended evolution stage. In the disclosed architecture, the initial time state 202, the cost-minimum initialization state 204, the perturbation-injection stage 206, the fractional-evolution interval 208, and the click-time endpoint 210 together define a complete primordial sequence. This bounded sequence enables a practical solver design in which initialization, stepping, stopping, field finalization, and output branching are all computationally well defined. The bounded nature of the interval also facilitates deterministic scheduling, reproducibility, checkpointing, hardware sizing, and performance benchmarking.

In some embodiments, the duration and structure of the fractional-evolution interval 208 may be represented to users or external systems through the optional SI bridge 214, while in other embodiments the interval remains entirely internal to the solver. Likewise, in some embodiments the click-time endpoint 210 may trigger immediate transition into the CMB-generation branch 218, whereas in other embodiments the evolved primordial field output 212 may first be archived, validated, or duplicated into multiple downstream branches including the downstream branch 216. Accordingly, FIG. 2 should be understood as showing a representative temporal and branch structure rather than a single mandatory sequencing of all possible post-click operations.

Thus, FIG. 2 and the accompanying description provide written-description support for the temporal framing of the disclosed solver, including the use of t=0 as the modeled initial state, the definition of t_click, the use of native solver units, the optional mapping to SI units, the formation of an evolved primordial field at the click-time endpoint 210, and the subsequent branching into CMB-generation and other downstream computational paths. This timing architecture supports the broader method, system, and non-transitory computer-readable medium embodiments disclosed herein and provides the basis for the initialization and evolution workflows described in greater detail below.

With reference now to FIG. 3, a representative lattice initialization workflow 300 is shown. In the illustrated embodiment, the workflow 300 includes a spatial domain definition 302, a voxel lattice 304, a random-seed source 306, a perturbation scaler 308, an initialized recognition-scale field store 310, a boundary-condition module 312, a checkpoint buffer 314, and an initialized-state output 316. FIG. 3 illustrates a representative initialization path by which the solver defines a computational domain, constructs a discretized lattice, prepares or receives seed information, generates perturbations, forms an initialized recognition-scale field, and stores that field in a form suitable for downstream fractional evolution. Although FIG. 3 presents one representative sequence, one or more of the illustrated stages may be merged, subdivided, reordered, repeated, distributed, or implemented in different hardware and software combinations without departing from the scope of the invention.

The spatial domain definition 302 is configured to define the computational domain over which the recognition-scale field will be represented and evolved. In representative embodiments, the spatial domain definition 302 specifies the dimensionality, extent, discretization framework, coordinate indexing, partitioning scheme, and memory layout to be used for the initial field. In many embodiments, the spatial domain definition 302 establishes a three-dimensional volumetric domain corresponding to the solver lattice. The spatial domain may be defined in native solver units, normalized units, scaled units, or other computational units suitable for subsequent spectral and temporal processing. The spatial domain definition 302 may further determine lattice dimensions, domain decomposition, buffer alignment, stride layout, accelerator tiling, and other data-placement features relevant to efficient execution on CPUs, GPUs, FPGAs, clusters, or hybrid systems.

The voxel lattice 304 is configured to instantiate the discretized spatial representation used by the solver. In representative embodiments, the voxel lattice 304 comprises a three-dimensional lattice of discrete volumetric elements on which the recognition-scale field C_RP is stored and updated. Representative lattice sizes include 512\hat{ }3, 1024\hat{ }3, 2048\hat{ }3, 4096\hat{ }3, and 8192\hat{ }3, although other lattice sizes, anisotropic lattice arrangements, padded lattice dimensions, or distributed multi-domain arrangements may be used. In some embodiments, the voxel lattice 304 is stored as a contiguous array in system memory or accelerator memory. In some embodiments, the voxel lattice 304 is partitioned into tiles, slabs, blocks, pages, or subdomains for distributed execution or accelerator-friendly data movement. The voxel lattice 304 may further include metadata indicating dimensionality, extent, indexing conventions, precision, memory ownership, decomposition layout, or alignment constraints.

In representative embodiments, the voxel lattice 304 is selected to balance resolution, memory use, runtime, and target output fidelity. For example, a 4096\hat{ }3 lattice may be used as a representative large-scale embodiment for high-resolution primordial field evolution, while smaller lattices such as 512\hat{ }3, 1024\hat{ }3, or 2048\hat{ }3 may be used for test runs, convergence studies, reduced-runtime embodiments, development runs, or validation sweeps. In some embodiments, an 8192\hat{ }3 lattice may be used for higher-resolution or extended-output studies. The invention is not limited to any single lattice dimension, and the voxel lattice 304 may be configured according to hardware resources, desired multipole reach, memory constraints, or target computational throughput.

The random-seed source 306 is configured to provide one or more seeds or seed-generating inputs used to create perturbations for the initial field. In representative embodiments, the random-seed source 306 may provide a fixed seed, a user-specified seed, a machine-generated seed, a pseudo-random seed, a cryptographically generated seed, a deterministic sequence seed, a batch-run seed, or a seed derived from an external scheduling or orchestration system. In some embodiments, the random-seed source 306 is implemented as a software random-number generator executing on a host processor. In some embodiments, the random-seed source 306 includes accelerator-resident random generation logic. In some embodiments, the random-seed source 306 may read seed values from configuration files, APIs, job descriptors, or execution manifests. The random-seed source 306 may also store, echo, log, or otherwise preserve the seed value for reproducibility and provenance capture.

In embodiments emphasizing determinism, the random-seed source 306 may operate in a repeatable mode such that identical seed values and identical solver settings generate identical perturbation fields and therefore support deterministic reproduction of the initialized state. In other embodiments, the random-seed source 306 may operate in a non-repeatable or entropy-influenced mode for exploratory or ensemble runs. In some embodiments, the workflow 300 may support batch ingestion of multiple seeds for ensemble studies, seed sweeps, convergence studies, or statistical validation workflows. Accordingly, the random-seed source 306 may function not only as a perturbation initiator but also as a control point for reproducibility, uncertainty characterization, and multi-run orchestration.

The perturbation scaler 308 is configured to generate, shape, normalize, or apply perturbations to the baseline field state. In representative embodiments, the perturbation scaler 308 receives base random or pseudo-random values from the random-seed source 306 and scales them to a desired perturbation magnitude. In one representative embodiment, the perturbation scaler 308 applies white-noise perturbations of approximately 10\hat{ }-5 amplitude to the baseline field. In other embodiments, the perturbation scaler 308 may impose different amplitudes, different spectral shapes, bounded value ranges, seeded mode structures, normalization rules, or frequency-domain shaping. The perturbation scaler 308 may also perform clipping, centering, bias removal, normalization to a target variance, amplitude-range enforcement, or transformation into a field-compatible numeric format.

In some embodiments, the perturbation scaler 308 may operate directly in the spatial domain by assigning per-voxel perturbation values across the voxel lattice 304. In some embodiments, the perturbation scaler 308 may operate in a transformed or partially transformed domain, for example by generating perturbative content in k-space or by applying a mode-filtered or scale-conditioned perturbation profile that is then mapped into the initialized field. In some embodiments, the perturbation scaler 308 may be configured to generate perturbations that are statistically white, approximately white, band-limited, scale-conditioned, or otherwise adapted to a desired initialization regime. The perturbation scaler 308 may therefore be implemented as a simple amplitude multiplier, a normalization pipeline, a spectral-conditioning engine, or a more structured perturbation-generation unit depending on the needs of a given embodiment.

The initialized recognition-scale field store 310 is configured to retain the resulting initialized field after baseline setup and perturbation application. In representative embodiments, the initialized recognition-scale field store 310 contains the field C_RP in a form ready for downstream fractional evolution. In some embodiments, the initialized recognition-scale field store 310 stores a field initialized around a cost minimum and then perturbed by the perturbation scaler 308. In some embodiments, the initialized recognition-scale field store 310 stores multiple versions of the initialized field, such as a raw baseline field, a post-perturbation field, a normalized field, and a field packaged for accelerator transfer. In some embodiments, the initialized recognition-scale field store 310 is embodied in accelerator memory for immediate downstream FFT and temporal processing. In some embodiments, the initialized recognition-scale field store 310 is embodied in host memory or persistent storage and later transferred into compute resources.

In representative embodiments, the initialized recognition-scale field store 310 may also preserve auxiliary metadata associated with the initialized field, including lattice dimensions, precision mode, seed identifiers, perturbation amplitude, normalization settings, generation timestamp, execution environment, run identifier, and configuration references. Such metadata may later be used for provenance capture, validation traceability, checkpoint restart, debugging, or reproduction of a run. In some embodiments, the initialized recognition-scale field store 310 may support versioning of multiple initialized states, such as one state for a control run, another for a modified-precision run, and another for a distinct seed in an ensemble.

The boundary-condition module 312 is configured to establish, store, or enforce one or more boundary-condition treatments for the initialized lattice. In some embodiments, the boundary-condition module 312 may specify periodic boundary conditions. In some embodiments, the boundary-condition module 312 may specify reflective, absorptive, open, wrapped, padded, or other boundary treatments. In some embodiments, the boundary-condition module 312 may simply record that the subsequent spectral pipeline assumes a particular periodic or wrap-compatible interpretation of the lattice. In some embodiments, the boundary-condition module 312 may insert guard regions, halo cells, ghost layers, or padding regions to support later FFT execution, block decomposition, or boundary-safe update operations. The invention is not limited to any one boundary-condition treatment so long as the field can be consistently initialized and subsequently evolved.

The checkpoint buffer 314 is configured to preserve an initialization-stage snapshot, an intermediate lattice image, metadata associated with initialization, or another record sufficient to support restart, audit, provenance, or downstream branch control. In representative embodiments, the checkpoint buffer 314 stores the initialized field after perturbation scaling and before the start of the main fractional-evolution interval. In some embodiments, the checkpoint buffer 314 may retain additional artifacts, such as raw seed values, perturbation statistics, lattice summaries, memory-layout descriptions, execution timestamps, and version identifiers. The checkpoint buffer 314 may be embodied in RAM, non-volatile memory, local disk, network storage, object storage, or any other medium suitable for preserving initialization state. In some embodiments, the checkpoint buffer 314 allows the solver to resume from the initialized-state boundary without reconstructing the lattice from scratch.

The initialized-state output 316 is configured to provide the initialized field and any associated metadata to downstream solver stages, including the spectral fractional operator, the temporal integrator, the non-linear cost core, or storage and validation subsystems. In representative embodiments, the initialized-state output 316 comprises one or more buffers, references, pointers, descriptors, file outputs, or transferred memory regions containing the initialized C_RP field. In some embodiments, the initialized-state output 316 may include a field image prepared specifically for GPU transfer, FPGA ingress, distributed cluster partitioning, or CPU-side execution. In some embodiments, the initialized-state output 316 may include one or more validation signatures or summaries used to verify that initialization completed correctly before the main evolution begins.

In a representative initialization flow, the spatial domain definition 302 first establishes the dimensional and structural properties of the computational domain, after which the voxel lattice 304 is instantiated according to the selected size and layout. The random-seed source 306 then provides one or more seed values or seed-driven perturbation inputs, and the perturbation scaler 308 generates and applies perturbations to the baseline field state. The resulting initialized field is stored in the initialized recognition-scale field store 310, while the boundary-condition module 312 records or imposes the boundary treatment to be used by later stages. A snapshot of the initialized state may then be written to the checkpoint buffer 314, and the initialized-state output 316 provides the resulting initialized field to the fractional evolution pipeline. This flow may be executed once for a single run, repeated for multiple runs, or batched across multiple seeds or lattice sizes.

The workflow 300 is not limited to embodiments in which initialization occurs entirely on a single device or in a single memory space. In some embodiments, the spatial domain definition 302 and voxel lattice 304 may be created on a host CPU, the perturbation scaler 308 may run on a GPU, and the initialized recognition-scale field store 310 may reside in accelerator memory. In other embodiments, the random-seed source 306 and perturbation scaler 308 may be implemented on an FPGA or within a distributed execution framework. In still other embodiments, the initialized field may be created in one environment and serialized for later use in another environment. Thus, FIG. 3 should be understood as illustrating functional roles rather than mandating a single physical implementation arrangement.

The workflow 300 also supports ensemble and convergence use cases. For example, the random-seed source 306 may be driven repeatedly with different seeds while holding lattice size and other parameters fixed, thereby enabling seed-ensemble studies. Similarly, the spatial domain definition 302 and voxel lattice 304 may be varied across different runs, such as 512\hat{ }3, 1024\hat{ }3, 2048\hat{ }3, and 4096\hat{ }3, to support resolution-convergence analysis while keeping the random-seed source 306 and perturbation scaler 308 under controlled conditions. These uses illustrate that the lattice initialization workflow 300 is not merely a preliminary setup stage, but also a point of control for experimental design, validation, reproducibility, and prosecution-support disclosure relating to the breadth of the disclosed solver architecture.

Thus, FIG. 3 and the accompanying description provide written-description support for defining the computational domain, constructing the voxel lattice 304, sourcing and scaling perturbations through the random-seed source 306 and perturbation scaler 308, storing the initialized recognition-scale field in the initialized recognition-scale field store 310, handling boundary conditions through the boundary-condition module 312, preserving restart and provenance information through the checkpoint buffer 314, and delivering an initialized-state output 316 to the downstream fractional-evolution pipeline. This initialization framework supports the later spectral, temporal, and output-generation stages of the disclosed Big-Click cosmogenesis solver.

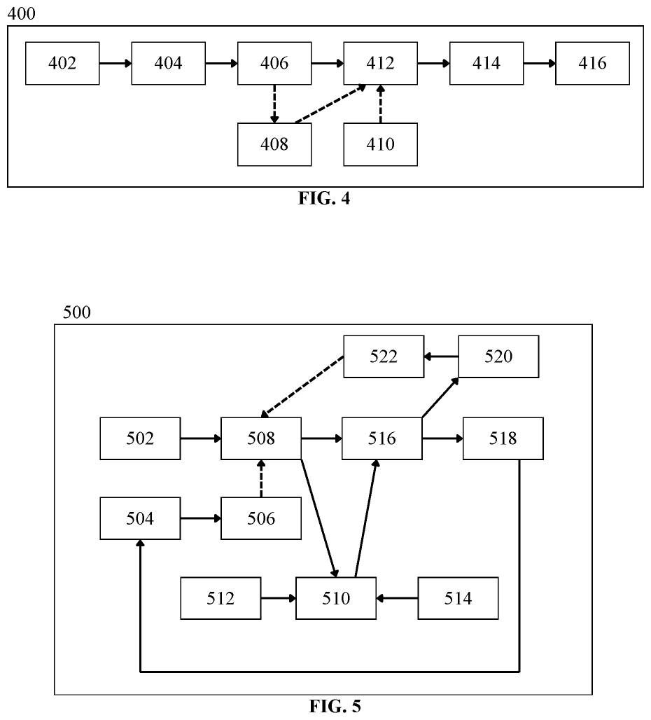

With reference now to FIG. 4, a representative spectral fractional-operator workflow 400 is shown. In the illustrated embodiment, the workflow 400 includes an input field buffer 402, a forward FFT engine 404, a k-space array 406, a wavenumber generator 408, an optional softening-scale input 410, a spectral multiplier 412, an inverse FFT engine 414, and a spatially updated field output 416. FIG. 4 illustrates a representative implementation of the spatial portion of the disclosed fractional d'Alembertian evolution path, in which a recognition-scale field is transformed into a spectral-domain representation, modified according to a fractional spatial operator, and transformed back into the spatial domain for subsequent temporal processing, cost-functional evaluation, or additional solver operations. Although FIG. 4 presents one representative arrangement, the functional blocks may be merged, split, reordered, pipelined, distributed, or accelerator-mapped in various ways without departing from the scope of the invention.

In representative embodiments, the field evolution is governed at least in part by a fractional d'Alembertian relation of the form: Box\hat{ }(5/12)C_RP(x,t)=0 .

where C_RP(x,t) is the recognition-scale field, Box denotes the d'Alembertian operator, and the exponent 5/12 specifies the fractional order. In the spectral representation used by the workflow 400, the corresponding fractional operator may be expressed as: Box_hat\hat{ }(5/12)=(−omega\hat{ }2+|k|\hat{ }2)\hat{ }(5/12).

where omega denotes temporal frequency and k denotes a wavevector or spatial-frequency quantity. In the disclosed workflow 400, the spatial portion of this operator is implemented through spectral-domain processing driven by one or more Fourier transforms and one or more multipliers acting on spectral-domain field data.

The input field buffer 402 is configured to receive or hold a field state for spectral processing. In representative embodiments, the input field buffer 402 receives an initialized recognition-scale field from the initialized-state output of the lattice initialization workflow or receives an updated field state produced by a prior temporal update, prior cost-functional evaluation, prior checkpoint reload, or other upstream stage. The input field buffer 402 may store full-resolution lattice data, a partitioned or tiled view of lattice data, a transformed representation prepared for FFT input, or a device-local copy of field data intended for accelerator execution. In some embodiments, the input field buffer 402 resides in host memory. In some embodiments, the input field buffer 402 resides in GPU memory, FPGA-accessible memory, distributed memory, or other execution-local storage.

The forward FFT engine 404 is configured to transform the field in the input field buffer 402 from the spatial domain into a spectral-domain representation. In representative embodiments, the forward FFT engine 404 performs a three-dimensional FFT on the input lattice field in order to generate a transformed field representation. The forward FFT engine 404 may be implemented using a software FFT library, a GPU FFT library, a custom transform kernel, an FPGA streaming FFT block, a distributed FFT framework, or any other transform implementation suitable for large-lattice spectral processing. In some embodiments, the forward FFT engine 404 operates on the full lattice at once. In some embodiments, the forward FFT engine 404 operates on partitions, slabs, tiles, or decomposed subdomains that are later combined or processed in parallel.

The k-space array 406 is configured to store the transformed field data after execution of the forward FFT engine 404. In representative embodiments, the k-space array 406 contains a spectral-domain representation C_tilde_RP(k) of the recognition-scale field. The k-space array 406 may comprise complex-valued elements, real-valued elements, packed transform outputs, symmetric spectral-domain structures, or other transformed data formats depending on the transform implementation. In some embodiments, the k-space array 406 is stored in accelerator memory to permit immediate multiplication by one or more spectral terms. In some embodiments, the k-space array 406 may also store metadata describing indexing, symmetry, padding, Nyquist handling, frequency ordering, or transform normalization.

The wavenumber generator 408 is configured to generate or provide the spectral-domain coordinate values used to define the spatial fractional operator. In representative embodiments, the wavenumber generator 408 computes, stores, or supplies one or more wavevector quantities k, one or more magnitudes |k|, one or more squared magnitudes |k|\hat{ }2, one or more indexing maps, and any associated coefficients used to evaluate the desired spectral multiplier. In some embodiments, the wavenumber generator 408 precomputes all required wavenumber values for a selected lattice size and memory layout. In some embodiments, the wavenumber generator 408 computes values on demand. In some embodiments, the wavenumber generator 408 provides tables, vectors, tensor-product factors, or compressed forms that may be expanded or reused during repeated update cycles. The wavenumber generator 408 may also account for lattice spacing, transform ordering, decomposition topology, or spectral padding conventions.

The optional softening-scale input 410 is configured to provide an optional scale parameter to the spectral-processing path in embodiments that use a softened or otherwise modified spatial operator. In some embodiments, the optional softening-scale input 410 may provide a quantity such as k0=pi/phi. In such embodiments, the optional softening-scale input 410 may be used to define a softened spectral multiplier, a regularized low-k response, a modified fractional kernel, a scale-conditioned filter, or another numerically modified spectral pathway. However, if such a softening-scale embodiment is retained in the application, the computational role of k0 should be expressly described in the written description and not left only as unexplained claim language. Accordingly, the optional softening-scale input 410 is shown in FIG. 4 as an optional pathway that may be invoked where the corresponding spectral implementation is explicitly disclosed.

The spectral multiplier 412 is configured to apply the spatial fractional operator to the transformed field data in the k-space array 406. In representative embodiments, the spectral multiplier 412 receives transformed field values from the k-space array 406 and receives wavevector information from the wavenumber generator 408, and then multiplies the transformed field by one or more spectral factors corresponding to the spatial fractional evolution. In one representative embodiment, the spectral multiplier 412 applies the factor: |k|\hat{ }(5/6).

to implement the spatial fractional component associated with the disclosed 5/12 operator order.

In some embodiments, the spectral multiplier 412 may include additional scaling, normalization, filtering, masking, low-k conditioning, or regularization terms. In some embodiments, the spectral multiplier 412 may incorporate the optional softening-scale input 410. In some embodiments, the spectral multiplier 412 may be implemented as a vectorized software kernel, a GPU kernel, an FPGA multiply pipeline, a distributed multiplication pass, or another spectral-domain arithmetic stage.

In representative embodiments, the spectral multiplier 412 may be understood as implementing the sequence: Forward FFT->k-space array->spectral multiplication->Inverse FFT.

This sequence permits the spatial fractional operator to be evaluated efficiently for large lattices by moving the computationally significant portion of the spatial update into the spectral domain. Relative to direct spatial-domain stencil approaches, this spectral implementation may provide substantial computational advantages for large-domain fractional operators, particularly where repeated updates are required over multiple time steps and where accelerator resources are available. The workflow 400 is therefore especially well suited for the large-lattice cosmogenesis simulations contemplated in the present disclosure.

The inverse FFT engine 414 is configured to transform the spectrally modified field back into the spatial domain. In representative embodiments, the inverse FFT engine 414 receives the spectrally updated field from the spectral multiplier 412 and performs an inverse three-dimensional FFT to generate a spatial-domain field suitable for downstream processing. The inverse FFT engine 414 may be implemented using the same general class of resources as the forward FFT engine 404, including software transform libraries, GPU FFT support, FPGA streaming transform blocks, or distributed transform frameworks. In some embodiments, the inverse FFT engine 414 may also perform normalization, scaling, output packing, data rearrangement, or memory transfer operations as part of the return path to the spatial domain.

The spatially updated field output 416 is configured to store, expose, or transfer the spatial-domain field resulting from the spectral update. In representative embodiments, the spatially updated field output 416 provides an updated field state to the temporal integrator, the non-linear cost core, a checkpointing subsystem, a validation subsystem, or another downstream component of the solver architecture. In some embodiments, the spatially updated field output 416 is written directly into a buffer used by the temporal update path. In some embodiments, the spatially updated field output 416 is retained in accelerator memory for immediate continued execution. In some embodiments, the spatially updated field output 416 is copied into host memory, persistent storage, or a distributed communication layer. The spatially updated field output 416 may therefore function both as a data product of the spatial fractional-operator workflow 400 and as an interface point to later stages of the overall solver.

In a representative operational flow, the input field buffer 402 receives the current field state, the forward FFT engine 404 transforms that field into a spectral-domain representation, and the resulting transformed field is stored in the k-space array 406. The wavenumber generator 408 supplies the wavevector values required for spectral processing, and the spectral multiplier 412 applies the desired fractional spatial factor, such as |k|\hat{ }(5/6), optionally together with one or more scaling or regularization terms. The inverse FFT engine 414 then returns the updated field to the spatial domain, and the resulting field is written to the spatially updated field output 416 for further processing. This operational flow may be repeated at each time step, at selected time steps, or at other intervals determined by the scheduler and temporal update logic of the overall solver architecture.

The workflow 400 is not limited to a single hardware implementation. In some embodiments, the forward FFT engine 404, the spectral multiplier 412, and the inverse FFT engine 414 may all execute on one or more GPUs. In some embodiments, one or more of those functions may execute on an FPGA, with the k-space array 406 stored in on-chip or off-chip accelerator memory and the spectral multiplier 412 implemented as a streaming or pipelined arithmetic path. In some embodiments, the FFT operations may be coordinated by a host CPU with transform data passed to accelerator kernels for multiplication. In still other embodiments, the workflow 400 may be distributed across nodes in a cluster, with decomposition-aware FFT operations and distributed spectral multiplication. Thus, FIG. 4 should be understood as showing functional modules rather than requiring a single fixed hardware partition.

The workflow 400 is also not limited to embodiments in which the spectral multiplier 412 is applied in a purely static or one-size-fits-all manner. In some embodiments, the spectral multiplier 412 may vary according to precision mode, lattice size, execution target, regularization policy, branch configuration, or numerical stability policy. In some embodiments, the optional softening-scale input 410 may be activated only in selected runs, such as validation runs, alternative embodiments, or claim-support embodiments. In some embodiments, different spectral multipliers may be used for scalar-mode, tensor-mode, or polarization-related paths, provided the corresponding implementations are expressly supported in the written description.

The workflow 400 provides an efficient way to implement the spatial component of the disclosed fractional d'Alembertian evolution while preserving compatibility with large-lattice execution, accelerator-based computation, and repeated temporal stepping. By expressing the spatial update in the spectral domain, the disclosed architecture avoids the need for cumbersome direct-space approximations of the fractional spatial operator and enables a practical large-scale solver suitable for cosmogenesis simulation. The use of the input field buffer 402, forward FFT engine 404, k-space array 406, wavenumber generator 408, optional softening-scale input 410, spectral multiplier 412, inverse FFT engine 414, and spatially updated field output 416 therefore provides concrete written-description support for a broad class of implementations in which the spatial fractional operator is executed spectrally.

Thus, FIG. 4 and the accompanying description provide written-description support for receiving a field into the input field buffer 402, transforming that field with the forward FFT engine 404, storing transformed data in the k-space array 406, generating spectral coordinates with the wavenumber generator 408, optionally providing a softening-scale through the optional softening-scale input 410, applying a fractional spectral multiplier through the spectral multiplier 412, returning the field to the spatial domain using the inverse FFT engine 414, and supplying an updated field through the spatially updated field output 416. This spatial spectral-processing framework forms one of the central implementation paths of the disclosed Big-Click cosmogenesis solver.

With reference now to FIG. 5, a representative temporal update and cost-core workflow 500 is shown. In the illustrated embodiment, the workflow 500 includes a current-state buffer 502, a history buffer 504, a Grunwald-Letnikov weight generator 506, a fractional-time derivative block 508, a non-linear cost evaluator 510, a reciprocal-evaluation block 512, a polynomial approximation block 514, a state-combination block 516, a next-state output 518, a step counter 520, and a termination checker 522. FIG. 5 illustrates a representative implementation of the temporal portion of the disclosed fractional d'Alembertian evolution path together with a representative non-linear cost-evaluation path that may be executed within the same update loop, in an interleaved manner, or in another coordinated sequence. Although FIG. 5 shows one representative arrangement, the illustrated functions may be distributed, fused, reordered, pipelined, or partitioned across different compute resources without departing from the scope of the invention.

In representative embodiments, the temporal portion of the disclosed solver uses a fractional time-evolution path rather than a conventional integer-order update alone. In one representative embodiment, the temporal fractional relation may be expressed as: d\hat{ }(5/6) C_RP/dt\hat{ }(5/6)~=(Delta t)\hat{ }(−5/6)*sum_{j=0}\hat{ }{n}w_j*C_RP(t−j*Delta t) where C_RP denotes the recognition-scale field, Delta t denotes a selected time-step interval, and w_j denotes Grunwald-Letnikov weights. In representative embodiments, the weights satisfy: w_0=1 and w_j=w_{j−1}*(1−(5/6+1)/j).

This temporal fractional structure permits the current field state to depend not only on an immediately preceding time step, but also on weighted historical states retained over a selected time horizon. Accordingly, the workflow 500 is designed to maintain state history, compute or retrieve appropriate weights, and combine those elements into a temporal update suitable for use within the broader Big-Click evolution pipeline.

The current-state buffer 502 is configured to hold the current field state to be temporally advanced. In representative embodiments, the current-state buffer 502 stores the spatially updated field produced by the spectral fractional-operator workflow, stores a prior temporally updated field, or stores another field state selected for the next temporal update operation. The current-state buffer 502 may be embodied in host memory, GPU memory, FPGA-accessible memory, distributed memory, or another storage medium suitable for repeated read and write access during iterative solver execution. In some embodiments, the current-state buffer 502 stores the full lattice field. In some embodiments, the current-state buffer 502 stores a partition, tile, slab, or decomposed subdomain. In some embodiments, the current-state buffer 502 may also store metadata describing time index, precision mode, current step number, or normalization status.

The history buffer 504 is configured to retain one or more earlier field states needed for the fractional temporal update. In representative embodiments, the history buffer 504 stores a time-ordered sequence of prior states corresponding to previous values of C_RP(t−j*Delta t). Because the fractional derivative path uses weighted contributions from historical states rather than relying only on an immediately preceding state, the history buffer 504 provides a practical mechanism for preserving the temporal memory of the evolving field. In some embodiments, the history buffer 504 stores all prior states accumulated since the start of the click interval. In some embodiments, the history buffer 504 stores only a selected rolling window of prior states. In some embodiments, the history buffer 504 may use compressed storage, partitioned storage, ring-buffer storage, distributed storage, or checkpoint-assisted recovery of older states.

In representative embodiments, the size and organization of the history buffer 504 may depend on selected step size, selected number of time steps, desired approximation order, hardware memory capacity, and execution precision. For example, in a representative embodiment using Delta t=0.1*t_click, the click interval may be traversed in 10 time steps, and the history buffer 504 may therefore retain up to 10 relevant states or a selected subset thereof. In alternative embodiments using smaller Delta t, adaptive stepping, or branch-specific time schedules, the history buffer 504 may retain a larger set of historical states. The history buffer 504 may also be coordinated with checkpointing logic such that selected historical states can be reconstructed, paged, or restored when needed.

The Grunwald-Letnikov weight generator 506 is configured to compute, retrieve, store, or provide the weights used in the fractional temporal update. In representative embodiments, the Grunwald-Letnikov weight generator 506 begins with w_0=1 and then recursively computes later weights according to w_j=w_{j−1}*(1−(5/6+1)/j). In some embodiments, the Grunwald-Letnikov weight generator 506 computes weights on demand at runtime. In some embodiments, the Grunwald-Letnikov weight generator 506 precomputes weights for a given step schedule and stores them in a table or coefficient memory. In some embodiments, the Grunwald-Letnikov weight generator 506 may produce weights in floating-point form, fixed-point form, rational approximation form, or other encoded forms suitable for the selected execution environment.

In some embodiments, the Grunwald-Letnikov weight generator 506 may also apply normalization, truncation, precision management, stability conditioning, or thresholding to the weight sequence. For example, weights below a selected magnitude may be truncated or compressed for efficiency in selected hardware embodiments. In some embodiments, the Grunwald-Letnikov weight generator 506 may generate different weight sequences for different temporal branches or for different embodiments using different fractional exponents. In the representative embodiments primarily described herein, however, the Grunwald-Letnikov weight generator 506 provides the weights corresponding to the disclosed 5/6 temporal order associated with the broader 5/12 fractional d'Alembertian framework.

The fractional-time derivative block 508 is configured to combine the current field state with the stored historical field states and corresponding weights in order to generate a fractional temporal update. In representative embodiments, the fractional-time derivative block 508 reads the current field from the current-state buffer 502, reads one or more prior states from the history buffer 504, receives weight values from the Grunwald-Letnikov weight generator 506, and computes a weighted sum corresponding to the selected fractional derivative approximation. In some embodiments, the fractional-time derivative block 508 applies the prefactor (Delta t)\hat{ }(−5/6) to the weighted sum. In some embodiments, the fractional-time derivative block 508 also applies scaling, normalization, accumulation staging, precision conversion, overflow handling, or buffering of intermediate sums. The fractional-time derivative block 508 may therefore be implemented as a vectorized software kernel, GPU kernel, FPGA arithmetic pipeline, distributed reduction pass, or another suitable historical-combination mechanism.

In representative embodiments, the fractional-time derivative block 508 may operate over the full lattice field, over selected lattice partitions, or over streamed subregions. In some embodiments, the fractional-time derivative block 508 may be fused with the state-combination block 516 or with the non-linear cost evaluator 510 for improved throughput. In some embodiments, the fractional-time derivative block 508 may operate in a staged manner, first computing weighted history contributions and then applying other update terms. In some embodiments, the fractional-time derivative block 508 may be implemented in a mixed-precision scheme, such as higher precision for accumulation and lower precision for storage. The invention is not limited to any one implementation so long as the fractional historical dependence of the temporal update is preserved.

The non-linear cost evaluator 510 is configured to compute the non-linear cost-functional contribution associated with the field state being temporally advanced. In representative embodiments, the non-linear cost evaluator 510 evaluates: J_cost(X)=0.5*(X+1/X)−1=cosh(log(X))−1.

for one or more field-derived values X. The non-linear cost evaluator 510 may receive X values directly from the current-state buffer 502, from outputs of the fractional-time derivative block 508, from normalized field representations, or from another intermediate field-processing stage. In some embodiments, the non-linear cost evaluator 510 operates at every temporal step. In some embodiments, the non-linear cost evaluator 510 operates at selected temporal steps. In some embodiments, the non-linear cost evaluator 510 may operate on all voxels, while in other embodiments it may operate on selected voxels, sampled regions, reduced representations, or branch-specific data paths.

The reciprocal-evaluation block 512 is configured to support evaluation of the reciprocal term appearing in J_cost(X). In representative embodiments, the reciprocal-evaluation block 512 computes or approximates 1/X for use by the non-linear cost evaluator 510. In some embodiments, the reciprocal-evaluation block 512 includes range checking or positivity guarding to prevent invalid or unstable reciprocal evaluation. In some embodiments, the reciprocal-evaluation block 512 may clamp, regularize, or transform input values that fall below a selected threshold, near zero, or outside a selected operating range. In FPGA-oriented embodiments, the reciprocal-evaluation block 512 may be implemented as a pipelined reciprocal approximation unit, a lookup-assisted reciprocal unit, a polynomial reciprocal approximator, or another fixed-point-compatible reciprocal path. In software or GPU embodiments, the reciprocal-evaluation block 512 may use floating-point reciprocal instructions, refined reciprocal approximations, or library-backed arithmetic.

The polynomial approximation block 514 is configured to support approximate evaluation of the non-linear cost function in embodiments using a piecewise-polynomial or other approximated arithmetic path. In representative embodiments, particularly FPGA embodiments, the polynomial approximation block 514 stores or accesses one or more polynomial segments and corresponding coefficients that approximate all or part of the function J_cost(X). In some embodiments, the polynomial approximation block 514 may be used together with the reciprocal-evaluation block 512 to produce an approximation of 0.5*(X+1/X)−1. In some embodiments, the polynomial approximation block 514 may approximate an equivalent transformed expression, such as a function of log(X) or another intermediate variable. In representative embodiments, the polynomial approximation block 514 may support an 8-segment approximation with maximum approximation error less than 10\hat{ }-6, although other segment counts, approximation families, and error bounds may be used.

In some embodiments, the polynomial approximation block 514 may also include segment-selection logic, coefficient memory, interpolation logic, rounding logic, error reporting, and overflow or underflow detection. In some embodiments, the polynomial approximation block 514 may be bypassed in embodiments using exact or floating-point evaluation. In some embodiments, the polynomial approximation block 514 may be invoked only in selected modes, such as low-power FPGA execution or high-throughput inference-style execution. Thus, the polynomial approximation block 514 provides written-description support for practical non-linear cost-core implementations rather than limiting the invention to any single arithmetic style.

The state-combination block 516 is configured to combine one or more contributions in order to produce an updated field state for the next temporal stage. In representative embodiments, the state-combination block 516 receives output from the fractional-time derivative block 508, receives cost-related information from the non-linear cost evaluator 510, and combines those results with the current field state, normalization factors, stability terms, or other update inputs in order to generate an updated state. In some embodiments, the state-combination block 516 performs addition, subtraction, scaling, clipping, normalization, dampening, or accumulation of intermediate terms. In some embodiments, the state-combination block 516 may also enforce stability-related conditions, range limits, or branch-specific update rules. In some embodiments, the state-combination block 516 may be implemented as part of a fused update kernel. In other embodiments, it may be implemented as a distinct arithmetic or logic stage.

The next-state output 518 is configured to store, output, or transfer the updated field produced by the temporal update workflow 500. In representative embodiments, the next-state output 518 provides the updated field to the current-state buffer 502 for the next iteration, stores the updated field in the history buffer 504 as part of the evolving time history, and/or transfers the updated field to another solver stage such as the spectral fractional-operator workflow, a checkpointing subsystem, a validation subsystem, or an output-generation stage. In some embodiments, the next-state output 518 may include a complete updated lattice field. In some embodiments, the next-state output 518 may include a partitioned representation, compressed representation, branch-specific representation, or accelerator-local representation of the field.

The step counter 520 is configured to track advancement through the click interval. In representative embodiments, the step counter 520 increments once per temporal step, once per fused spatial-temporal cycle, or according to another configured scheduler event. The step counter 520 may store an absolute step number, a relative step index, a remaining-step count, or one or more branch-specific counters. In some embodiments, the step counter 520 may also store metadata including the corresponding time value, checkpoint index, output interval, or validation trigger. The step counter 520 therefore provides a simple but important scheduling function by permitting the workflow 500 to determine how far the solver has progressed toward the click-time endpoint.

The termination checker 522 is configured to determine whether the temporal evolution has reached the desired stopping criterion. In representative embodiments, the termination checker 522 compares the current step count, accumulated time, or equivalent progress metric against the selected click-time target t_click. In some embodiments, the termination checker 522 concludes that the click interval is complete when a selected number of scheduled steps has been performed, such as 10 steps in a representative embodiment using Delta t=0.1*t_click. In some embodiments, the termination checker 522 uses tolerance-based comparison against accumulated time. In some embodiments, the termination checker 522 may additionally evaluate one or more stability, convergence, checkpoint, or branch-trigger conditions before allowing advancement to the next stage. When the stopping criterion is met, the termination checker 522 may trigger final state storage, checkpoint generation, downstream branching, radiation-transfer activation, or related post-evolution operations.

In a representative temporal-update flow, the current-state buffer 502 provides the field state to be advanced, the history buffer 504 provides retained earlier states, and the Grunwald-Letnikov weight generator 506 supplies the fractional weights used by the fractional-time derivative block 508. The fractional-time derivative block 508 then generates a historical weighted update contribution. In parallel, serially, or in an interleaved manner, the non-linear cost evaluator 510 computes the relevant cost-functional contribution, optionally with support from the reciprocal-evaluation block 512 and the polynomial approximation block 514. The state-combination block 516 then combines the temporal and cost-related contributions to generate an updated field, which is supplied through the next-state output 518. The step counter 520 is updated, and the termination checker 522 determines whether the click interval has been completed or whether another temporal step should be performed. This loop may continue until the termination criterion associated with t_click is satisfied.

The workflow 500 is not limited to a single hardware mapping. In some embodiments, the current-state buffer 502, history buffer 504, and fractional-time derivative block 508 may be implemented on GPUs, while the non-linear cost evaluator 510 may be executed as a GPU kernel or as a separate FPGA-resident cost core. In some embodiments, the reciprocal-evaluation block 512 and polynomial approximation block 514 may be implemented in FPGA logic while the step counter 520 and termination checker 522 are managed by a host processor. In still other embodiments, the entire workflow 500 may execute in software on general-purpose processors. Thus, FIG. 5 should be understood as defining functional roles and supported execution paths rather than requiring a single rigid implementation.

The workflow 500 is also not limited to embodiments in which temporal integration and non-linear cost evaluation are always performed as distinct sequential stages. In some embodiments, the non-linear cost evaluator 510 may operate before the fractional-time derivative block 508. In some embodiments, the non-linear cost evaluator 510 may operate after the state-combination block 516. In some embodiments, the non-linear cost evaluator 510 may be partially fused into the state-combination block 516 or evaluated on reduced or transformed data. In some embodiments, selected time steps may omit certain optional calculations for performance reasons, while still preserving the overall disclosed temporal and cost-functional structure. Accordingly, the arrangement shown in FIG. 5 should be understood as a representative workflow rather than an inflexible micro-architecture.

The workflow 500 provides a practical temporal implementation of the disclosed Big-Click evolution path by combining historical weighting, controllable step scheduling, non-linear cost-functional evaluation, and explicit stopping logic. By using the current-state buffer 502, history buffer 504, Grunwald-Letnikov weight generator 506, fractional-time derivative block 508, non-linear cost evaluator 510, reciprocal-evaluation block 512, polynomial approximation block 514, state-combination block 516, next-state output 518, step counter 520, and termination checker 522, the disclosed solver can realize the temporal portion of the fractional d'Alembertian framework in a way that is executable at scale and adaptable to software, GPU, FPGA, and hybrid platforms. FIG. 5 and the accompanying description therefore provide concrete written-description support for the temporal and non-linear update machinery used in the disclosed cosmogenesis solver.

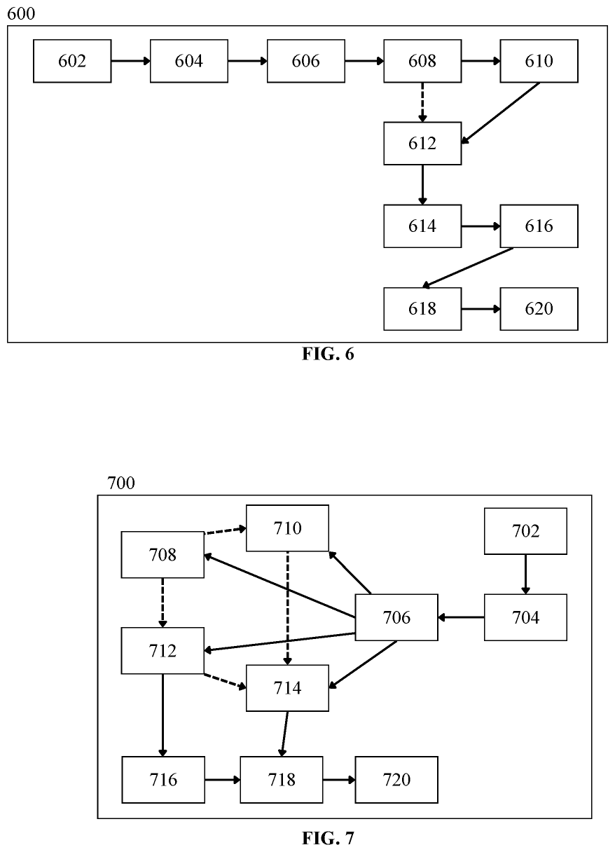

With reference now to FIG. 6, a representative output-generation workflow 600 is shown. In the illustrated embodiment, the workflow 600 includes an evolved primordial field input 602, a source-function generator 604, a line-of-sight integrator 606, a sky-map generator 608, a sky discretization grid 610, a spherical harmonic decomposition engine 612, an a_lm store 614, a C_l calculator 616, a reference-comparison module 618, and a report generator 620. FIG. 6 illustrates a representative pathway by which an evolved recognition-scale field produced at the end of the Big Click interval is converted into observable-output quantities suitable for scientific analysis, validation, reporting, comparison with reference cosmic microwave background datasets, and downstream use. Although the blocks of FIG. 6 are shown in one representative sequence for clarity, one or more of the illustrated functions may be combined, reordered, repeated, bypassed, or distributed across multiple compute resources without departing from the scope of the invention.

The evolved primordial field input 602 is configured to receive the field state generated at the completion of the primordial fractional-evolution interval. In representative embodiments, the evolved primordial field input 602 receives the evolved recognition-scale field C_RP corresponding to the click-time endpoint and treats that field as a primordial perturbation field suitable for downstream observable-output generation. The evolved primordial field input 602 may be provided directly from a temporal update pipeline, from a checkpointed field image, from accelerator memory, from host memory, or from persistent storage. In some embodiments, the evolved primordial field input 602 contains the full lattice-resolution field. In some embodiments, the evolved primordial field input 602 contains a transformed, reduced, filtered, branch-specific, or resampled version of the evolved field. In some embodiments, metadata accompanying the evolved primordial field input 602 may include lattice size, seed identifier, precision mode, time-step schedule, scaling selections, and provenance information.

The source-function generator 604 is configured to derive, compute, or otherwise prepare one or more source-function quantities for use in generation of observable sky outputs. In representative embodiments, the source-function generator 604 interprets the evolved primordial field input 602 as a source or precursor of radiative perturbation information and computes a source function S for use in a line-of-sight integration path. In some embodiments, the source-function generator 604 may generate a source function internally according to solver-specific rules. In some embodiments, the source-function generator 604 may interface with or invoke a transfer pipeline analogous to the type used in CAMB-or CLASS-like frameworks, but using the RS-derived evolved field instead of a conventional inflationary power-spectrum input. In some embodiments, the source-function generator 604 may produce scalar-mode source terms, tensor-mode source terms, polarization-related source terms, or branch-specific source functions depending on the selected embodiment.

In representative embodiments, the source-function generator 604 produces source-function data suitable for use in a line-of-sight formulation of observable temperature perturbations. One representative expression for the corresponding output path is: DeltaT/T(n_hat)=integral S(tau, n_hat) d tau where S denotes a source function, tau denotes an integration variable, and n_hat denotes a line-of-sight direction. The source-function generator 604 may therefore prepare values of S, intermediate transfer quantities, branch-conditioned coefficients, or discretized line-of-sight source data suitable for subsequent integration. In some embodiments, the source-function generator 604 may also apply normalization, filtering, interpolation, projection, or rescaling operations needed to match the requirements of the selected line-of-sight integration strategy.

The line-of-sight integrator 606 is configured to integrate source-function information along one or more selected directions in order to generate radiative sky-output data. In representative embodiments, the line-of-sight integrator 606 performs a computation according to DeltaT/T (n_hat)=integral S(tau, n_hat) d tau, thereby converting the source-function data into direction-dependent perturbation values on the sky. In some embodiments, the line-of-sight integrator 606 may numerically integrate over a discretized set of line-of-sight steps. In some embodiments, the line-of-sight integrator 606 may operate using quadrature, interpolation-assisted integration, tabulated transfer kernels, projected radial shells, or other numerical approaches. In some embodiments, the line-of-sight integrator 606 may be executed internally within the same software or hardware environment as the preceding solver stages. In other embodiments, the line-of-sight integrator 606 may be executed through an interfaced or modular output engine.

In representative embodiments, the line-of-sight integrator 606 may operate separately or jointly over temperature, polarization, tensor, or branch-specific source-function pathways. In some embodiments, the line-of-sight integrator 606 may generate direct direction-indexed perturbation values. In some embodiments, the line-of-sight integrator 606 may generate intermediate sky-grid data, transfer bundles, harmonic-ready coefficients, or line-of-sight response arrays. The line-of-sight integrator 606 may also incorporate last-scattering-surface traversal logic, source-window selection, discretization control, and numerical-precision management. The invention is not limited to any one integration algorithm so long as the evolved primordial field is converted into sky-observable data through a line-of-sight or equivalent radiation-transfer mechanism.

The sky-map generator 608 is configured to assemble or write sky-referenced output data based on the perturbation information produced by the line-of-sight integrator 606. In representative embodiments, the sky-map generator 608 constructs one or more temperature maps, polarization maps, tensor-related maps, or derived sky products from the integrated line-of-sight outputs. In some embodiments, the sky-map generator 608 may produce a full-sky map. In some embodiments, the sky-map generator 608 may produce a reduced map, a branch-specific map, a multipole-limited map, a diagnostic map, or a visualization-ready map. The sky-map generator 608 may also apply projection, interpolation, smoothing, masking, normalization, coordinate conversion, metadata attachment, or output formatting. In some embodiments, the sky-map generator 608 may write map files to storage. In some embodiments, the sky-map generator 608 may stream map data directly to the spherical harmonic decomposition engine 612.

The sky discretization grid 610 is configured to define the discrete spherical sampling or pixelization framework used for the generated sky data. In representative embodiments, the sky discretization grid 610 comprises a HEALPix grid or an equivalent discretization framework suitable for representing full-sky or partial-sky data. In one representative embodiment, the sky discretization grid 610 uses N_side=2048, although other sky resolutions may be used. In some embodiments, the sky discretization grid 610 is selected to correspond to a target output multipole range, a desired map resolution, a hardware limit, a reporting standard, or an observational-comparison requirement. In some embodiments, the sky discretization grid 610 may include pixel metadata, coordinate mappings, ring or nested indexing information, and other supporting information used by later map-analysis or harmonic-decomposition stages.

The spherical harmonic decomposition engine 612 is configured to decompose the sky data into spherical-harmonic coefficients. In representative embodiments, the spherical harmonic decomposition engine 612 computes coefficients according to: DeltaT/T(n_hat)=sum_{l,m}a_lm*Y_lm(n_hat) where Y_lm denotes a spherical-harmonic basis function and a_lm denotes the corresponding coefficient. In some embodiments, the spherical harmonic decomposition engine 612 operates on sky data generated by the sky-map generator 608 and represented on the sky discretization grid 610. In some embodiments, the spherical harmonic decomposition engine 612 may operate directly on direction-dependent outputs from the line-of-sight integrator 606. The spherical harmonic decomposition engine 612 may be implemented in software, on accelerators, or using mixed compute resources depending on output size and performance targets.

In representative embodiments, the spherical harmonic decomposition engine 612 may generate temperature coefficients, polarization coefficients, cross-mode coefficients, or other branch-specific harmonic outputs. In some embodiments, the spherical harmonic decomposition engine 612 may compute coefficients over all supported multipoles up to a selected l_max, such as 2500 in one representative embodiment. In some embodiments, the spherical harmonic decomposition engine 612 may operate over selected multipole bands, reduced coefficient sets, or diagnostic ranges. The spherical harmonic decomposition engine 612 may also apply weighting, normalization, masking corrections, coordinate conversions, or precision management appropriate to the chosen decomposition framework.

The a_lm store 614 is configured to retain the spherical-harmonic coefficients produced by the spherical harmonic decomposition engine 612. In representative embodiments, the a_lm store 614 stores one or more coefficient sets corresponding to temperature outputs, polarization outputs, tensor outputs, cross-spectra outputs, or other harmonic decompositions. In some embodiments, the a_lm store 614 stores full-resolution harmonic coefficients. In some embodiments, the a_lm store 614 stores reduced or compressed coefficient sets, branch-filtered coefficient sets, or multipole-limited coefficient subsets. In some embodiments, the a_lm store 614 may also store associated metadata including l_max, decomposition settings, sky-grid resolution, normalization conventions, masks, provenance identifiers, and execution history.

The C_l calculator 616 is configured to compute one or more angular power spectra based on the harmonic coefficients stored in or supplied to the a_lm store 614. In representative embodiments, the C_l calculator 616 computes: C_l=(1/(2*l+1))*sum_m|a_lm|\hat{ }2.

for one or more multipoles l. In some embodiments, the C_l calculator 616 computes temperature power spectra. In some embodiments, the C_l calculator 616 computes cross-spectra or polarization spectra, such as TT, TE, EE, or BB outputs. In some embodiments, the C_l calculator 616 may compute derived summary quantities, peak locations, residual bands, low-l statistics, or branch-specific observables in addition to or instead of raw C_l values. In some embodiments, the C_l calculator 616 may operate on-the-fly during harmonic generation, while in other embodiments it may operate as a downstream post-processing stage.

The reference-comparison module 618 is configured to compare generated observable outputs against one or more reference datasets, target spectra, validation ranges, or acceptance criteria. In representative embodiments, the reference-comparison module 618 receives C_l data from the C_l calculator 616 and compares that data against reference cosmic microwave background data, including reference TT spectra and, in optional embodiments, TE and EE spectra. In some embodiments, the reference-comparison module 618 computes residuals across selected multipole bands such as 2-30, 30-800, 800-1500, and 1500-2500. In some embodiments, the reference-comparison module 618 may extract peak positions, compare those peak positions with reference values, assess overall residual magnitude, evaluate consistency thresholds, compute low-l metrics, or perform branch-specific validation operations.

In representative embodiments, the reference-comparison module 618 may operate not only as a validation unit but also as a reporting-preparation unit. For example, the reference-comparison module 618 may assemble tables, summary metrics, confidence-band outputs, peak summaries, anomaly metrics, or pass/fail indicators to be consumed by downstream reporting logic. In some embodiments, the reference-comparison module 618 may also compare outputs across multiple seeds, across multiple lattice sizes, across multiple precision modes, or across multiple hardware runs. The reference-comparison module 618 may therefore support single-run validation, ensemble validation, convergence analysis, and prosecution-support characterization of the disclosed solver.

The report generator 620 is configured to generate one or more output reports, files, bundles, visualizations, or export packages based on the outputs of the workflow 600. In representative embodiments, the report generator 620 receives data from one or more of the sky-map generator 608, the a_lm store 614, the C_l calculator 616, and the reference-comparison module 618, and produces human-readable and/or machine-readable reports. Such reports may include spectra, coefficient summaries, map visualizations, benchmark summaries, residual tables, peak comparisons, low-l metrics, provenance bundles, validation summaries, or API-ready output packages. In some embodiments, the report generator 620 writes files to persistent storage. In some embodiments, the report generator 620 returns outputs through a host interface, cloud service, visualization system, or downstream analysis pipeline.

In a representative operational flow, the evolved primordial field input 602 receives the evolved field from the Big Click solver, the source-function generator 604 derives the source-function information used for observable-output construction, and the line-of-sight integrator 606 computes direction-dependent perturbation outputs based on those source terms. The sky-map generator 608 organizes those outputs into one or more sky maps defined over the sky discretization grid 610. The spherical harmonic decomposition engine 612 then decomposes the sky data into coefficients, which are retained in the a_lm store 614. The C_l calculator 616 computes the corresponding angular power spectrum, the reference-comparison module 618 compares the generated observables with one or more reference datasets or validation criteria, and the report generator 620 produces the resulting reports and output bundles. This flow may be executed in a single pipeline, in staged fashion, in branch-specific fashion, or through distributed execution across multiple compute resources.

The workflow 600 is not limited to a single output mode. In some embodiments, the evolved primordial field input 602 may feed a temperature-only branch. In some embodiments, the source-function generator 604 and line-of-sight integrator 606 may support polarization or tensor branches in addition to or instead of temperature outputs. In some embodiments, the sky-map generator 608 may generate educational visualization outputs or reduced diagnostic products, while in other embodiments the workflow 600 may produce research-grade coefficient sets and high-resolution spectra. Thus, FIG. 6 should be understood as a general observable-output framework rather than a single fixed product pipeline.

The workflow 600 is also not limited to a single implementation environment. In some embodiments, the source-function generator 604 and line-of-sight integrator 606 may execute on CPUs, while the spherical harmonic decomposition engine 612 executes on a GPU. In some embodiments, map generation and harmonic decomposition may be executed in software after the primordial field has already been checkpointed and transferred from accelerator memory. In some embodiments, certain portions of the reference-comparison module 618 and report generator 620 may execute in a cloud environment or as part of a service-oriented architecture. Accordingly, FIG. 6 defines functional modules and supported pathways rather than mandating a single hardware topology.

The workflow 600 provides a practical pathway by which the evolved recognition-scale field generated by the disclosed Big Click solver is converted into reference-comparable observables. By including the evolved primordial field input 602, the source-function generator 604, the line-of-sight integrator 606, the sky-map generator 608, the sky discretization grid 610, the spherical harmonic decomposition engine 612, the a_lm store 614, the C_l calculator 616, the reference-comparison module 618, and the report generator 620, the present disclosure provides concrete written-description support for a full observable-output architecture rather than merely disclosing an upstream primordial field computation. FIG. 6 and the accompanying description therefore support broad method, system, hardware, and non-transitory computer-readable medium embodiments directed to the generation of cosmic microwave background outputs from the disclosed fractional-evolution solver.

With reference now to FIG. 7, a representative GPU implementation architecture 700 is shown. In the illustrated embodiment, the architecture 700 includes a host processor 702, system memory 704, an accelerator interconnect 706, a first GPU 708, a second GPU 710, a third GPU 712, a fourth GPU 714, an FFT library module 716, a GPU cost-kernel module 718, and an output aggregator 720. FIG. 7 illustrates one representative hardware arrangement for executing the disclosed Big-Click cosmogenesis solver on multiple graphics-processing units so as to support large-lattice field evolution, repeated spectral transforms, non-linear cost-functional evaluation, and output-generation support at practical runtime. Although four GPUs are shown for convenience and because that arrangement corresponds to one representative embodiment, the invention is not limited to four accelerators, to any particular GPU product, or to any single vendor-specific topology.

The host processor 702 is configured to coordinate execution of the overall solver pipeline and to manage interactions among the remaining components of the architecture 700. In representative embodiments, the host processor 702 performs one or more of configuration parsing, seed ingestion, click-time setup, job scheduling, memory orchestration, kernel launch control, inter-device synchronization, checkpoint coordination, validation triggering, and output packaging. In some embodiments, the host processor 702 may comprise one or more CPUs, such as a multi-core server processor. In some embodiments, the host processor 702 may also manage API requests, cloud job intake, storage interactions, and report-generation control. The host processor 702 may operate as a single control point or may be distributed across multiple processors or orchestration layers without departing from the scope of the invention.

The system memory 704 is configured to store executable instructions, configuration data, intermediate data products, checkpoint states, seed information, field partitions, validation data, and output bundles associated with execution of the solver. In representative embodiments, the system memory 704 stores one or more copies of the initialized field, metadata associated with lattice decomposition, time-history control data, provenance records, and host-side staging buffers used to move data between the host processor 702 and the GPU devices 708, 710, 712, and 714. In some embodiments, the system memory 704 may also store precomputed wavenumber tables, Grunwald-Letnikov weights, branch-specific control structures, and map-generation buffers. The system memory 704 may comprise RAM, persistent memory, memory-mapped storage, or a combination of memory resources.

The accelerator interconnect 706 is configured to provide communication among the host processor 702, the system memory 704, and the GPU devices 708, 710, 712, and 714. In representative embodiments, the accelerator interconnect 706 may comprise a high-bandwidth interconnect supporting peer-to-peer transfers, coordinated memory access, collective operations, synchronization events, and movement of field partitions or transformed data among accelerators. In one representative embodiment, the accelerator interconnect 706 supports a four-GPU arrangement corresponding to a 4x-GPU implementation. In some embodiments, the accelerator interconnect 706 may be embodied by a GPU-to-GPU fabric, a PCIe-based arrangement, a switch fabric, or another accelerator communication pathway. The invention is not limited to any one interconnect technology so long as the architecture can support the movement and synchronization required by the disclosed solver.

The first GPU 708, second GPU 710, third GPU 712, and fourth GPU 714 are configured to execute one or more accelerator-resident portions of the disclosed cosmogenesis solver. In representative embodiments, the GPUs 708, 710, 712, and 714 collectively execute the large-scale lattice evolution associated with the spectral fractional-operator path, the temporal fractional-integration path, the non-linear cost-functional path, or combinations thereof. In some embodiments, the field lattice may be partitioned across the GPUs 708, 710, 712, and 714 according to slabs, tiles, blocks, or another decomposition scheme. In some embodiments, different GPUs may execute similar kernels over different field partitions. In some embodiments, certain GPUs may perform FFT-dominant work while others perform cost-functional or reduction-dominant work. In some embodiments, each GPU executes a similar mixture of spectral, temporal, and cost-functional kernels over its assigned field region.

In representative embodiments, the four-GPU arrangement shown in FIG. 7 is used to support large-lattice execution, such as execution on a 4096\hat{ }3 lattice. In such embodiments, the field may be decomposed across the GPUs 708, 710, 712, and 714 so that each accelerator processes a portion of the overall lattice while the host processor 702 coordinates initialization, global scheduling, checkpointing, and final aggregation. This arrangement can reduce per-device memory pressure and can increase throughput relative to a single-device configuration. In one representative implementation, the architecture 700 may complete a 4096\hat{ }3 simulation in approximately 17 minutes on a 4x-GPU arrangement, although such timing is a representative benchmark rather than a required limitation of the invention.

The FFT library module 716 is configured to provide transform support for the spectral fraction-operator stages executed on the GPU devices. In representative embodiments, the FFT library module 716 provides routines, kernels, plans, workspaces, and transform orchestration support for forward and inverse FFT processing of the recognition-scale field. In some embodiments, the FFT library module 716 may correspond to a vendor-provided GPU FFT library. In some embodiments, the FFT library module 716 may comprise a custom transform framework or a hybrid library-plus-custom-kernel implementation. The FFT library module 716 may support three-dimensional FFT execution, partition-aware FFT execution, batched FFT execution, transform-plan reuse, precision control, and normalization control. In some embodiments, the FFT library module 716 may also coordinate inter-device exchanges needed to complete multi-GPU transforms.

The GPU cost-kernel module 718 is configured to execute the non-linear cost-functional path on one or more of the GPU devices. In representative embodiments, the GPU cost-kernel module 718 evaluates J_cost(X)=0.5*(X+1/X)−1=cosh(log(X))−1 over selected field values or over all relevant field values on the partition resident at a given GPU. In some embodiments, the GPU cost-kernel module 718 includes reciprocal evaluation, range checking, normalization, vectorized arithmetic, and reduction support. In some embodiments, the GPU cost-kernel module 718 may be fused with temporal update logic or invoked as a separate kernel after completion of a temporal update stage. In some embodiments, the GPU cost-kernel module 718 may operate in floating-point precision appropriate to the selected run mode. The GPU cost-kernel module 718 may therefore serve as one of the main accelerator-resident components responsible for high-throughput execution of the disclosed non-linear solver path.

In representative embodiments, the GPUs 708, 710, 712, and 714 may cooperate in executing both the FFT-intensive and cost-kernel-intensive portions of the solver. For example, field partitions may be transformed using the FFT library module 716, multiplied by spectral terms, returned to the spatial domain, temporally advanced, and then supplied to the GPU cost-kernel module 718 for non-linear cost evaluation. This process may repeat for each scheduled time step until the click interval is complete. In some embodiments, synchronization points may occur between transform and update phases, between time steps, or at checkpoint boundaries. In some embodiments, asynchronous execution and overlapping transfer/compute scheduling may be used to improve throughput. The architecture 700 is therefore suitable for repeated large-scale solver cycles rather than only for a single isolated transform pass.

The output aggregator 720 is configured to collect, combine, store, or forward outputs generated by the GPU devices. In representative embodiments, the output aggregator 720 receives one or more updated field partitions, harmonic-ready data products, map-generation inputs, validation artifacts, benchmark metrics, or final output bundles from the GPUs 708, 710, 712, and 714. In some embodiments, the output aggregator 720 may reassemble partitioned lattice data into a unified field representation. In some embodiments, the output aggregator 720 may collect only derived outputs, such as summary metrics, residual information, or partial transforms. In some embodiments, the output aggregator 720 may provide aggregated outputs to host-side radiation-transfer modules, harmonic-decomposition modules, validation engines, output stores, or report generators. In some embodiments, the output aggregator 720 may also collect timing, memory-use, throughput, and device-status data for performance characterization.

In a representative operational flow, the host processor 702 receives a run request and configures the job using settings stored in or staged through the system memory 704. The lattice field is initialized and partitioned, and the partitions are distributed to the GPUs 708, 710, 712, and 714 through the accelerator interconnect 706. The FFT library module 716 supports spectral transforms on each GPU, while the GPU cost-kernel module 718 evaluates the non-linear cost-functional component associated with the evolving field. The host processor 702 coordinates step advancement, synchronization, checkpointing, and branch control, and the output aggregator 720 collects the resulting outputs for storage, comparison, or downstream use. This flow may be repeated for a single seed, for multiple seeds in an ensemble, for multiple lattice resolutions, or for branch-specific output runs.

The architecture 700 is not limited to embodiments in which every solver stage executes on the GPUs. In some embodiments, the host processor 702 may perform or coordinate portions of click-time computation, seed generation, weight generation, scheduler control, checkpointing, and validation. In some embodiments, radiation-transfer and harmonic-decomposition stages may be executed after the primary lattice evolution is complete, either on the host or on separate compute resources. In some embodiments, the GPUs 708, 710, 712, and 714 may be used only for the spectral and non-linear field-evolution stages, with downstream output generation handled elsewhere. Accordingly, FIG. 7 should be understood as illustrating a representative acceleration architecture for the core solver path rather than requiring that all stages of the complete application run exclusively on GPUs.

The architecture 700 is likewise not limited to four GPUs or to a specific GPU model. While FIG. 7 shows the first GPU 708, second GPU 710, third GPU 712, and fourth GPU 714 to illustrate one representative high-throughput embodiment, other embodiments may use one GPU, two GPUs, eight GPUs, or another number of accelerators. Similarly, while one representative embodiment may use high-performance data-center GPUs, the disclosed architecture may be implemented on other accelerator classes so long as the functional roles of spectral processing, temporal advancement, non-linear cost evaluation, and output aggregation are preserved. Thus, the inclusion of the four devices in FIG. 7 provides representative written-description support for a multi-GPU embodiment without limiting the claims to a particular accelerator count or vendor platform.

The architecture 700 provides a practical way to execute the disclosed Big-Click cosmogenesis solver on large-scale accelerator hardware while retaining the ability to support large lattices, repeated time stepping, spectral-domain processing, and non-linear cost evaluation within useful wall-clock intervals. By including the host processor 702, system memory 704, accelerator interconnect 706, GPUs 708, 710, 712, and 714, FFT library module 716, GPU cost-kernel module 718, and output aggregator 720, FIG. 7 and the accompanying description provide concrete written-description support for system and hardware embodiments of the disclosed solver. These embodiments are useful for high-resolution research runs, ensemble validation runs, large-lattice parameter-free cosmogenesis runs, and other execution contexts in which accelerator throughput and memory bandwidth are important.

Thus, FIG. 7 and the accompanying description provide written-description support for a multi-GPU architecture in which the host processor 702 coordinates execution, the system memory 704 stages data and metadata, the accelerator interconnect 706 supports inter-device communication, the GPUs 708, 710, 712, and 714 execute all or part of the solver pipeline, the FFT library module 716 provides transform functionality, the GPU cost-kernel module 718 provides non-linear cost-functional evaluation, and the output aggregator 720 combines and forwards outputs for downstream use. This architecture supports broad method, system, and hardware claims directed to accelerator-based implementation of the disclosed Big-Click cosmogenesis solver.

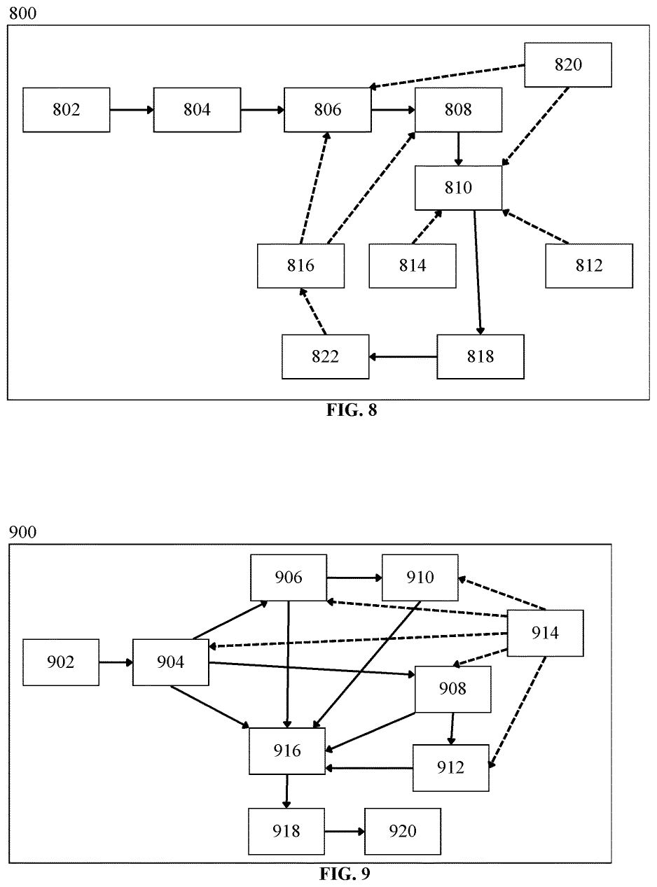

With reference now to FIG. 8, a representative FPGA implementation architecture 800 is shown. In the illustrated embodiment, the architecture 800 includes a host interface 802, an input DMA engine 804, an FFT engine 806, a spectral multiplication engine 808, a fixed-point cost core 810, a piecewise-polynomial coefficient store 812, a reciprocal and guard block 814, a pipeline controller 816, an output DMA engine 818, external memory 820, and a power-monitor or telemetry block 822. FIG. 8 illustrates a representative hardware architecture in which one or more field-evolution and non-linear cost-functional stages of the disclosed Big-Click cosmogenesis solver are implemented in reconfigurable logic so as to support reduced runtime, reduced energy consumption, streaming execution, and deterministic accelerator behavior. Although FIG. 8 presents one representative arrangement, the functions shown may be merged, repartitioned, duplicated, time-multiplexed, distributed across multiple FPGA devices, or combined with host-side and GPU-side resources without departing from the scope of the invention.

The host interface 802 is configured to couple the FPGA implementation architecture 800 to one or more external systems, including a host processor, host memory subsystem, scheduler, orchestration layer, storage layer, validation engine, or cloud-control interface. In representative embodiments, the host interface 802 receives configuration inputs, field-initialization data, seed-derived perturbation data, execution commands, branch selections, timing selections, and output-routing selections. The host interface 802 may also provide status outputs, runtime summaries, validation artifacts, provenance data, checkpoint references, spectra, maps, and other solver outputs back to the host environment. In some embodiments, the host interface 802 may be implemented over PCIe, coherent interconnect, chiplet-style interfaces, board-level fabric, or another digital host-to-accelerator communication path.

The input DMA engine 804 is configured to move data from the host-side environment into FPGA-accessible memory or directly into streaming hardware paths within the architecture 800. In representative embodiments, the input DMA engine 804 transfers one or more field partitions, initialization data, perturbation buffers, coefficient tables, scheduler settings, step-control values, wavenumber tables, and related metadata from host memory into the FPGA execution fabric. In some embodiments, the input DMA engine 804 operates in burst mode. In some embodiments, the input DMA engine 804 operates as a continuous stream feeder. In some embodiments, the input DMA engine 804 may support tiled field movement, double-buffering, scatter-gather transfer, partitioned domain transfer, or concurrent read/write windows to support sustained execution throughput.

The FFT engine 806 is configured to perform one or more forward and/or inverse transform operations associated with the spatial fractional-operator path. In representative embodiments, the FFT engine 806 implements a hardware FFT pipeline suitable for transforming lattice data from the spatial domain into a spectral-domain representation and for returning spectrally modified data to the spatial domain after multiplication. In some embodiments, the FFT engine 806 may be implemented as one or more streaming FFT blocks operating over partitioned field data. In some embodiments, the FFT engine 806 may process data in batched blocks, slab partitions, or tiled streams. In some embodiments, the FFT engine 806 may support fixed-point, floating-point, block-floating, or mixed-precision formats depending on the target embodiment and available resources. The FFT engine 806 may also include normalization support, data-order correction, staging FIFOs, and transform-plan control logic.

The spectral multiplication engine 808 is configured to apply the spectral-domain multiplier associated with the spatial portion of the disclosed fractional d'Alembertian operator. In representative embodiments, the spectral multiplication engine 808 receives transformed field values from the FFT engine 806 and applies a fractional spatial factor such as |k|\hat{ }(5/6) to those values. In some embodiments, the spectral multiplication engine 808 may also apply scaling, normalization, filtering, low-k conditioning, or optional regularization. In embodiments supporting a modified or softened kernel, the spectral multiplication engine 808 may incorporate a softening-scale input if expressly defined in the computational implementation. The spectral multiplication engine 808 may be implemented as a pipelined arithmetic path, as one or more multiply-accumulate structures, as a table-assisted multiplier path, or as another reconfigurable-logic implementation of the disclosed spectral multiplication step.

The fixed-point cost core 810 is configured to evaluate the non-linear cost functional used by the disclosed solver, and in the embodiment of FIG. 8 the fixed-point cost core 810 provides a dedicated FPGA-resident implementation of that evaluation. In representative embodiments, the fixed-point cost core 810 evaluates J_cost(X)=0.5*(X+1/X)−1=cosh(log(X))−1 using fixed-point arithmetic selected to balance precision, throughput, resource utilization, and power consumption. In one representative embodiment, the fixed-point cost core 810 uses 24-bit fixed-point arithmetic. In some embodiments, the fixed-point cost core 810 may receive field-derived values X from a temporally updated field stream, from a spatially updated field stream, from an intermediate normalized field stream, or from another stage of the solver pipeline. In some embodiments, the fixed-point cost core 810 may operate once per voxel per time step. In some embodiments, the fixed-point cost core 810 may operate on selected streams, subsampled streams, or branch-specific data paths.

The piecewise-polynomial coefficient store 812 is configured to store coefficients, segment definitions, thresholds, or related data used by approximate evaluation logic associated with the fixed-point cost core 810. In representative embodiments, the piecewise-polynomial coefficient store 812 retains coefficients for a piecewise-polynomial approximation of the cost function or one or more intermediate functions used in that evaluation. In one representative embodiment, the approximation is divided into 8 segments. The piecewise-polynomial coefficient store 812 may therefore hold a coefficient set for each segment, one or more selection thresholds or interval boundaries, scale values, offset values, error-bounding data, and segment metadata. In some embodiments, the piecewise-polynomial coefficient store 812 is implemented as FPGA block RAM, ultra RAM, distributed memory, LUT-backed storage, or external memory accessed under pipeline control.

The reciprocal and guard block 814 is configured to support safe and efficient evaluation of reciprocal terms and to protect the fixed-point cost core 810 against invalid or unstable inputs. In representative embodiments, the reciprocal and guard block 814 computes or approximates 1/X, checks whether input values fall within an expected range, and applies one or more guard conditions when values approach zero, exceed thresholds, or otherwise threaten invalid reciprocal evaluation. In some embodiments, the reciprocal and guard block 814 may clamp values to minimum or maximum thresholds. In some embodiments, the reciprocal and guard block 814 may flag out-of-range conditions, produce diagnostic outputs, or force fallback arithmetic. In some embodiments, the reciprocal and guard block 814 may be integrated tightly with the fixed-point cost core 810 so that reciprocal evaluation, range checking, and piecewise-polynomial evaluation occur in a single pipelined hardware path.

The pipeline controller 816 is configured to orchestrate the movement of data through the FPGA computation path and to coordinate the relative timing of the FFT engine 806, the spectral multiplication engine 808, the fixed-point cost core 810, the piecewise-polynomial coefficient store 812, the reciprocal and guard block 814, the external memory 820, and the DMA engines 804 and 818. In representative embodiments, the pipeline controller 816 manages stream initiation, stage enablement, scheduling, buffering, hazard avoidance, stall recovery, frame or tile boundaries, branch selection, checkpoint boundaries, and output flushing. In some embodiments, the pipeline controller 816 may also coordinate temporal update sequencing so that field values are advanced through a repeated per-step execution cycle. In some embodiments, the pipeline controller 816 may expose status registers, counters, fault flags, or telemetry hooks to the host interface 802.

The output DMA engine 818 is configured to move data out of the FPGA execution fabric and into host memory, storage, validation modules, or downstream output-generation modules. In representative embodiments, the output DMA engine 818 transfers spatially updated fields, temporally updated fields, cost-evaluated streams, checkpoint states, field partitions, summary outputs, validation metrics, and/or benchmark data from the architecture 800 to one or more external destinations. In some embodiments, the output DMA engine 818 may write back only final or intermediate field states. In some embodiments, the output DMA engine 818 may also return reduced products, such as performance summaries or low-volume diagnostics, while keeping bulk field data resident in the FPGA pipeline for additional passes. In some embodiments, the output DMA engine 818 may operate concurrently with the input DMA engine 804 to support overlapping read/write execution.

The external memory 820 is configured to store data and coefficients needed by the FPGA execution path when on-chip resources are insufficient or when larger streaming windows are desired. In representative embodiments, the external memory 820 may store field tiles, time-history buffers, coefficient tables, weight tables, transform staging buffers, checkpoint data, or intermediate pipeline outputs. In some embodiments, the external memory 820 may comprise high-bandwidth memory, DRAM, board-level memory, or another accessible memory resource. In some embodiments, the external memory 820 may be used to support larger lattice partitions, deeper time-history retention, or batched execution modes that would exceed strictly on-chip memory capacity. The external memory 820 may therefore extend the usable scale of the FPGA embodiment while still permitting high-throughput streaming operation.

The power-monitor or telemetry block 822 is configured to observe, record, or report power consumption, thermal behavior, throughput, fault conditions, stage utilization, clock-domain health, or other telemetry associated with execution of the architecture 800. In representative embodiments, the power-monitor or telemetry block 822 may provide energy-use summaries, run-time utilization data, and comparative efficiency data relative to other hardware embodiments. In some embodiments, the power-monitor or telemetry block 822 may also support dynamic control, such as throttling, clock adjustment, branch selection, or alert generation when telemetry thresholds are met. In some embodiments, the power-monitor or telemetry block 822 may provide data for efficiency-focused reports and validation artifacts, including reports comparing the FPGA embodiment to GPU embodiments.

In a representative operational flow, the host interface 802 receives configuration data and execution commands from a host-side environment, and the input DMA engine 804 transfers the necessary field data and control information into the FPGA execution path. The FFT engine 806 transforms field data for spectral processing, and the spectral multiplication engine 808 applies the fractional spatial multiplier to produce a spectrally updated representation. The fixed-point cost core 810 then evaluates the non-linear cost-functional path, optionally with support from the piecewise-polynomial coefficient store 812 and the reciprocal and guard block 814. The pipeline controller 816 coordinates these stages and determines how data is buffered, staged, and advanced through repeated execution cycles. Resulting outputs are transferred out through the output DMA engine 818, while the external memory 820 supports larger working sets and the power-monitor or telemetry block 822 records efficiency and performance data.

In representative embodiments, the architecture 800 may be used to accelerate all or part of the disclosed Big-Click cosmogenesis solver. In some embodiments, the FPGA path may be used primarily for the non-linear cost-functional portion of the workflow, with FFT processing handled elsewhere. In some embodiments, both FFT processing and cost-functional evaluation may be implemented on the FPGA. In some embodiments, the architecture 800 may act as a co-processor for a host-managed or GPU-assisted solver, while in other embodiments it may execute a substantial portion of the core field-evolution path. Accordingly, FIG. 8 should be understood as supporting a broad class of FPGA embodiments, ranging from tightly focused cost-core acceleration to more complete FPGA-resident solver pipelines.

The architecture 800 is not limited to a single fixed precision or approximation style. While one representative embodiment uses 24-bit fixed-point arithmetic, 8 piecewise-polynomial segments, and maximum approximation error less than 10\hat{ }-6, other precisions, segment counts, guard thresholds, coefficient formats, or evaluation schemes may be used. Likewise, while the architecture 800 may be implemented on one representative FPGA platform in a representative benchmark embodiment, the invention is not limited to any one FPGA family or product line. The significance of the architecture 800 is that it provides a concrete hardware path for streaming execution of the disclosed fractional-evolution and cost-functional operations with potentially improved runtime and energy efficiency relative to less-specialized compute environments.

In some representative embodiments, the FPGA implementation architecture 800 may complete a large-lattice solver run in approximately 6 minutes on a representative FPGA platform and may do so with improved energy efficiency relative to a representative multi-GPU embodiment. Such timing and efficiency values are representative benchmark results rather than required limitations of the invention, but they help illustrate the practical benefit of the FPGA path for high-throughput or energy-constrained deployment scenarios. The power-monitor or telemetry block 822 may be used to document such comparative results, and the host interface 802 may package those results into validation or reporting outputs.

The architecture 800 provides a concrete, executable hardware embodiment of the disclosed solver by pairing a spectral-processing path with a fixed-point non-linear cost-core path under deterministic pipeline control. By including the host interface 802, the input DMA engine 804, the FFT engine 806, the spectral multiplication engine 808, the fixed-point cost core 810, the piecewise-polynomial coefficient store 812, the reciprocal and guard block 814, the pipeline controller 816, the output DMA engine 818, the external memory 820, and the power-monitor or telemetry block 822, FIG. 8 and the accompanying description provide written-description support for broad FPGA-based method, system, and hardware claims directed to execution of the Big-Click cosmogenesis solver.

Thus, FIG. 8 and the accompanying description provide written-description support for an FPGA embodiment in which data is received through the host interface 802 and input DMA engine 804, transformed by the FFT engine 806, modified by the spectral multiplication engine 808, evaluated by the fixed-point cost core 810 with support from the piecewise-polynomial coefficient store 812 and reciprocal and guard block 814, orchestrated by the pipeline controller 816, stored or buffered in the external memory 820, returned through the output DMA engine 818, and monitored by the power-monitor or telemetry block 822. This FPGA architecture supports the disclosed solver's high-throughput, low-power, and hardware-accelerated execution paths.

With reference now to FIG. 9, a representative validation workflow 900 is shown. In the illustrated embodiment, the workflow 900 includes a simulation-output input 902, a TT comparison branch 904, a TE and EE comparison branch 906, a low-l metric branch 908, a seed-ensemble branch 910, a resolution-convergence branch 912, a reference dataset store 914, a residual calculator 916, an acceptance-criteria block 918, and a validation report output 920. FIG. 9 illustrates a representative framework by which outputs generated by the disclosed Big-Click cosmogenesis solver are assessed, compared, characterized, and reported. The workflow 900 may be used to validate scientific outputs, characterize hardware behavior, assess reproducibility, support prosecution-ready disclosure of representative performance, and distinguish the disclosed solver from prior parameter-fitting cosmology pipelines. Although FIG. 9 presents one representative arrangement, the illustrated branches may be executed sequentially, in parallel, selectively, repeatedly, or in batch form without departing from the scope of the invention.

The simulation-output input 902 is configured to receive one or more output products generated by the solver pipeline for validation analysis. In representative embodiments, the simulation-output input 902 receives one or more of evolved field outputs, sky maps, spherical-harmonic coefficients a_lm, angular power spectra C_l, branch-specific spectra, benchmark logs, runtime summaries, energy-use summaries, seed metadata, lattice metadata, or provenance bundles. In some embodiments, the simulation-output input 902 receives outputs from a single run. In some embodiments, the simulation-output input 902 receives outputs from multiple runs, such as multi-seed ensembles or multiple lattice resolutions. The simulation-output input 902 may ingest data directly from an output store, from a report-generation module, from a cloud service, or from staged validation storage.

The reference dataset store 914 is configured to retain one or more external or internal reference datasets against which solver outputs may be compared. In representative embodiments, the reference dataset store 914 stores one or more cosmic microwave background reference spectra, harmonic-reference products, uncertainty ranges, multipole-band summaries, low-l metric targets, or other comparison-ready reference data. In some embodiments, the reference dataset store 914 stores Planck-related TT data and optional TE and EE data. In some embodiments, the reference dataset store 914 may also store reference peaks, covariance data, binning rules, masks, selection windows, convergence baselines, or prior validated outputs of the disclosed solver used as internal references. The reference dataset store 914 may be embodied in local storage, a database, a memory-resident dataset, cloud storage, or another accessible data source.

The TT comparison branch 904 is configured to compare generated temperature power-spectrum outputs against one or more TT reference datasets. In representative embodiments, the TT comparison branch 904 receives one or more computed C_l\hat{ }TT outputs from the simulation-output input 902 and compares those outputs against corresponding TT reference data from the reference dataset store 914. In some embodiments, the TT comparison branch 904 evaluates multipole ranges including 2-30, 30-800, 800-1500, and 1500-2500. In some embodiments, the TT comparison branch 904 extracts or confirms the locations of one or more acoustic peaks, compares those peak locations to reference values, and generates branch-specific summaries of residual magnitude or agreement status. The TT comparison branch 904 may therefore function as a principal validation path for the temperature-output embodiment of the disclosed solver.

In representative embodiments, the TT comparison branch 904 may operate on full-resolution spectra, binned spectra, smoothed spectra, band-limited spectra, or branch-specific subsets of TT data. In some embodiments, the TT comparison branch 904 may compute residual curves, weighted residuals, sigma-scaled residuals, chi-like summary statistics, peak-offset values, or threshold-based agreement determinations. In some embodiments, the TT comparison branch 904 may generate outputs suitable for both scientific validation and patent-support reporting, including tables summarizing performance across multipole ranges. Exact reported values may vary by embodiment and run conditions, and any specific benchmark numbers should be understood as representative embodiments rather than limiting thresholds of operability.

The TE and EE comparison branch 906 is configured to compare generated cross-spectrum and polarization-spectrum outputs against one or more TE and EE reference datasets. In representative embodiments, the TE and EE comparison branch 906 may be activated in embodiments that generate polarization-related outputs, such as scalar-plus-polarization or tensor-related branches. The TE and EE comparison branch 906 may receive generated TE and EE spectra, compare those outputs against corresponding reference data from the reference dataset store 914, and produce branch-specific residuals, agreement summaries, or threshold determinations. In some embodiments, the TE and EE comparison branch 906 may also be adapted to compare BB data or other polarization-related outputs where such outputs are present. The TE and EE comparison branch 906 therefore supports broader validation of optional embodiments beyond temperature-only outputs.

The low-l metric branch 908 is configured to compute and evaluate one or more low-multipole metrics or anomaly-related quantities. In representative embodiments, the low-l metric branch 908 may process multipole-limited outputs corresponding to low-l ranges, such as l<=30, and may compute one or more quantities including quadrupole-related metrics, octupole-related metrics, alignment-angle metrics, S_1/2-type statistics, hemispherical-asymmetry measures, or related low-l quantities. In some embodiments, the low-l metric branch 908 may compare such metrics against values or ranges stored in the reference dataset store 914. In some embodiments, the low-l metric branch 908 may generate summaries indicating whether the disclosed solver reproduces or predicts low-l behaviors of interest. Because certain current claims and embodiments refer to low-l anomaly reproduction and prediction, the low-l metric branch 908 provides important written-description support for computational handling of those quantities.

The seed-ensemble branch 910 is configured to analyze outputs across multiple runs that differ in seed selection while holding other selected conditions constant. In representative embodiments, the seed-ensemble branch 910 receives outputs from a plurality of runs generated using different random or pseudo-random seeds, and evaluates how output spectra, residuals, peak locations, low-l metrics, or other observable quantities vary across the ensemble. In some embodiments, the seed-ensemble branch 910 may be used to demonstrate that the generated cosmic microwave background output is generic rather than finely tuned to a single realization. In some embodiments, the seed-ensemble branch 910 may compute ensemble means, spreads, confidence ranges, variance summaries, cosmic-variance-like quantities, or threshold comparisons. In one representative embodiment, the seed-ensemble branch 910 may process outputs from 1000 seed-distinct runs, although other ensemble sizes may be used.

The resolution-convergence branch 912 is configured to compare outputs generated at different lattice resolutions in order to assess convergence of the solver. In representative embodiments, the resolution-convergence branch 912 receives outputs corresponding to multiple lattice sizes, such as 512\hat{ }3, 1024\hat{ }3, 2048\hat{ }3, and 4096\hat{ }3, and compares the resulting spectra, peaks, residuals, or related observables across those lattice sizes. In some embodiments, the resolution-convergence branch 912 computes relative differences between outputs from adjacent lattice sizes or between the largest and second-largest lattice sizes. In some embodiments, the resolution-convergence branch 912 may determine whether changes between selected resolutions fall below a selected threshold for one or more multipole ranges. The resolution-convergence branch 912 therefore provides a practical way to characterize whether a given resolution is sufficient for a selected output regime.

The residual calculator 916 is configured to compute one or more residual quantities associated with the outputs compared in the branches of the workflow 900. In representative embodiments, the residual calculator 916 may compute absolute residuals, relative residuals, sigma-scaled residuals, weighted deviations, band-averaged deviations, peak offsets, or branch-specific error quantities. The residual calculator 916 may receive generated outputs from one or more of the branches 904, 906, 908, 910, and 912 and compare those outputs against reference values or acceptance ranges obtained from the reference dataset store 914. In some embodiments, the residual calculator 916 may produce branch-specific residual outputs. In some embodiments, the residual calculator 916 may produce a unified validation summary. In some embodiments, the residual calculator 916 may also compute hardware-oriented metrics such as runtime deviation, memory overhead, throughput variation, or energy-use deltas where benchmark validation is desired.

The acceptance-criteria block 918 is configured to determine whether one or more selected outputs satisfy one or more chosen validation criteria. In representative embodiments, the acceptance-criteria block 918 may test whether TT residuals fall within selected uncertainty ranges, whether TE and EE residuals satisfy selected thresholds, whether low-l metrics fall within selected comparison bands, whether seed ensembles exhibit acceptable spread, and whether resolution-convergence differences fall below selected tolerances. In some embodiments, the acceptance-criteria block 918 may apply branch-specific criteria or a composite criterion spanning multiple branches. In one non-limiting validation mode, the acceptance-criteria block 918 computes a sigma-scaled residual metric between a generated angular power spectrum and a reference angular power spectrum over a selected multipole range and designates a run “accepted” when (i) an overall residual for multipoles 2-2500 is less than or equal to 1.0 and (ii) each band residual is less than or equal to 1.5 for bands {2-30, 30-800, 800-1500, 1500-2500}. A run is designated “rejected” when either condition is not met, and the acceptance-criteria block 918 records the failing band(s) and the corresponding execution settings including seed, lattice size, time-step settings, and hardware mode in an associated provenance record. In some embodiments, the acceptance-criteria block 918 may also evaluate deterministic reproducibility, such as whether fixed-seed identical-setting runs yield matching or sufficiently matching outputs, and may output pass, fail, conditional, or further-review-required determinations depending on the selected validation framework.

The validation report output 920 is configured to produce one or more reports, tables, summaries, machine-readable packages, or archival records reflecting the results of the validation workflow 900. In representative embodiments, the validation report output 920 may provide a table of multipole-band residuals, peak comparisons, low-l metric summaries, seed-ensemble statistics, convergence summaries, hardware-performance summaries, and acceptance determinations. In some embodiments, the validation report output 920 may generate human-readable documents suitable for review, scientific analysis, or prosecution support. In some embodiments, the validation report output 920 may generate machine-readable outputs suitable for automated pipelines, dashboards, APIs, or cloud-delivered services. In some embodiments, the validation report output 920 may also include provenance records identifying seeds, lattice sizes, hardware platforms, execution settings, and reference datasets used in the validation process.

In a representative validation flow, the simulation-output input 902 receives one or more solver outputs and the reference dataset store 914 provides the corresponding reference data. The TT comparison branch 904 evaluates temperature spectra, the TE and EE comparison branch 906 evaluates optional polarization-related outputs, the low-l metric branch 908 evaluates low-multipole and anomaly-related quantities, the seed-ensemble branch 910 evaluates variation across seeds, and the resolution-convergence branch 912 evaluates consistency across lattice sizes. The residual calculator 916 computes the relevant residuals and differences, the acceptance-criteria block 918 determines whether selected criteria are satisfied, and the validation report output 920 produces the resulting reports and output bundles. This representative flow may be executed after each run, after selected runs, in batch mode, in cloud-orchestrated mode, or as part of a broader development or deployment cycle.

The workflow 900 is not limited to scientific-output validation alone. In some embodiments, the simulation-output input 902 may include hardware runtime logs, accelerator telemetry, power summaries, or memory-use summaries, and the residual calculator 916 and acceptance-criteria block 918 may also evaluate benchmark-related criteria. For example, a representative benchmark embodiment may compare runtime on a multi-GPU platform against runtime on an FPGA platform, or may compare power consumption and derived energy-use values across implementations. In such embodiments, the validation report output 920 may include hardware-oriented benchmark reports in addition to or instead of purely observational comparison reports. Thus, FIG. 9 supports both scientific validation and implementation-characterization workflows.

The workflow 900 is also not limited to embodiments in which every branch is always active. In some embodiments, only the TT comparison branch 904 may be enabled, such as in a temperature-only output embodiment. In some embodiments, the TE and EE comparison branch 906 may be omitted if polarization outputs are not generated. In some embodiments, the low-l metric branch 908 may be emphasized when low-l prediction or anomaly-related embodiments are being tested. In some embodiments, the seed-ensemble branch 910 and resolution-convergence branch 912 may be used primarily during development, internal validation, or prosecution-support studies. Accordingly, FIG. 9 should be understood as illustrating a modular validation architecture whose branches may be selected according to output mode, embodiment type, or deployment context.

The workflow 900 provides a concrete validation architecture for the disclosed solver by including not only reference comparison but also reproducibility, ensemble, convergence, and acceptance logic. By using the simulation-output input 902, TT comparison branch 904, TE and EE comparison branch 906, low-l metric branch 908, seed-ensemble branch 910, resolution-convergence branch 912, reference dataset store 914, residual calculator 916, acceptance-criteria block 918, and validation report output 920, the present disclosure provides written-description support for a comprehensive validation and benchmarking framework associated with the Big-Click cosmogenesis solver. FIG. 9 and the accompanying description therefore support broad method, system, hardware, and non-transitory computer-readable medium claims directed to validation, benchmarking, and acceptance analysis of the disclosed solver outputs.

Thus, FIG. 9 and the accompanying description provide written-description support for receiving simulation outputs through the simulation-output input 902, comparing those outputs using the TT comparison branch 904, TE and EE comparison branch 906, low-l metric branch 908, seed-ensemble branch 910, and resolution-convergence branch 912, supplying reference data from the reference dataset store 914, computing residuals with the residual calculator 916, applying one or more thresholds or rules in the acceptance-criteria block 918, and generating reports through the validation report output 920. This workflow gives the disclosed solver a prosecution-ready validation architecture rather than leaving output quality as an unsupported assertion.

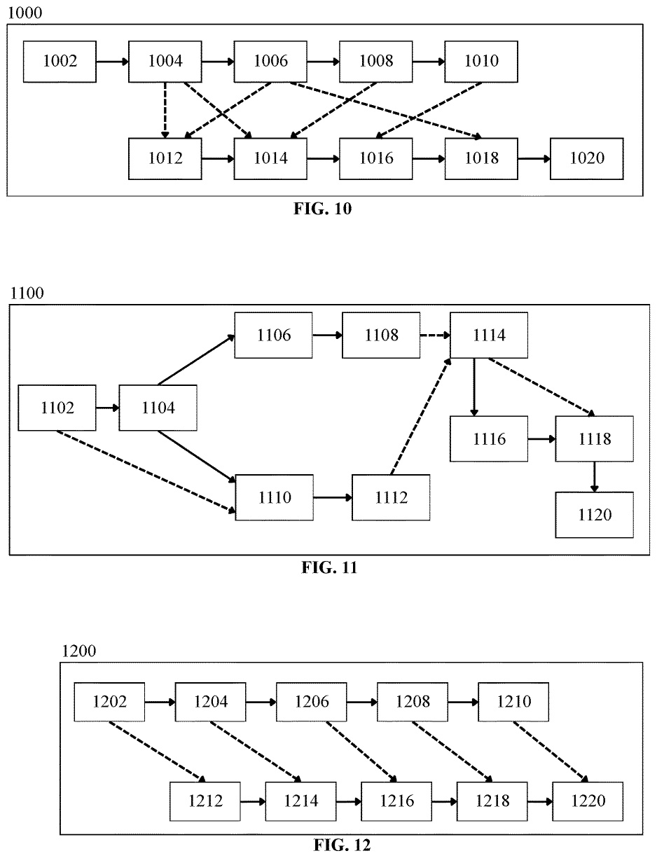

With reference now to FIG. 10, a representative alternative-embodiment architecture 1000 is shown. In the illustrated embodiment, the architecture 1000 includes a scalar-mode branch 1002, a tensor-mode branch 1004, a polarization module 1006, a reionization module 1008, a higher-resolution lattice module 1010, a gravitational-wave module 1012, an H0 extraction module 1014, a structure-formation export module 1016, a cloud API module 1018, and an educational visualization module 1020. FIG. 10 illustrates that the disclosed Big-Click cosmogenesis solver is not limited to a single temperature-only or single-platform implementation, but instead supports a family of alternative and downstream embodiments built on the same core click-time structure, lattice initialization path, fractional d'Alembertian evolution path, non-linear cost-functional core, and observable-output architecture. Although FIG. 10 shows one representative set of branches, additional branches, sub-branches, or combinations may be used without departing from the scope of the invention.

In representative embodiments, the modules and branches shown in FIG. 10 share a common inventive concept in that each embodiment executes (or consumes outputs produced by) the same core solver pipeline including (i) establishing a click-time interval, (ii) initializing a recognition-scale field on a lattice, (iii) evolving the field over the click interval using a fractional d'Alembertian evolution path with spectral spatial processing and fractional temporal integration, (iv) evaluating a non-linear cost function during evolution, and (v) generating at least one observable-output product including sky data, spherical-harmonic coefficients, angular power spectra, validation metrics, or provenance records. The alternative branches therefore represent different output modes, deployment modes, or downstream uses of a shared solver architecture rather than unrelated inventions.

The scalar-mode branch 1002 is configured to generate scalar-mode outputs associated with the primordial field-evolution pipeline. In representative embodiments, the scalar-mode branch 1002 uses the same initialized recognition-scale field, click-time interval, spectral spatial processing, temporal fractional integration, and cost-functional evaluation disclosed elsewhere herein, and directs the resulting evolved field into temperature-oriented or scalar-oriented radiation-transfer and harmonic-output pathways. In some embodiments, the scalar-mode branch 1002 may constitute the baseline or default execution branch of the solver. In some embodiments, the scalar-mode branch 1002 may operate as one branch among several simultaneously generated branches. The scalar-mode branch 1002 may therefore provide temperature spectra, scalar-mode maps, scalar-mode harmonic coefficients, and scalar-mode validation outputs while sharing the overall solver architecture with the alternative branches described below.

The tensor-mode branch 1004 is configured to generate tensor-related outputs or otherwise to extend the primordial evolution path to tensor-mode analysis. In representative embodiments, the tensor-mode branch 1004 may derive one or more tensor-related perturbation quantities from the evolved primordial field or from a tensor-extended field representation and may then route those quantities through one or more output-generation pathways. In some embodiments, the tensor-mode branch 1004 may provide inputs to the polarization module 1006, the gravitational-wave module 1012, or both. In some embodiments, the tensor-mode branch 1004 may use the same time grid, lattice structure, and fractional-operator machinery as the scalar-mode branch 1002 but apply branch-specific transfer rules, source-function construction, or decomposition logic. The tensor-mode branch 1004 therefore supports embodiments in which the solver is extended beyond scalar-only temperature outputs.

The polarization module 1006 is configured to generate polarization-related outputs, including in representative embodiments E-mode and B-mode outputs and optional cross-spectra. In some embodiments, the polarization module 1006 receives branch-specific source data from the scalar-mode branch 1002, the tensor-mode branch 1004, or both, and then constructs one or more polarization maps, harmonic coefficients, or spectra. In some embodiments, the polarization module 1006 generates TE, EE, and BB outputs suitable for comparison with reference datasets, internal validation, or downstream reporting. In some embodiments, the polarization module 1006 may generate map-level outputs for visualization or educational use. In some embodiments, the polarization module 1006 may be activated only in selected runs, such as research runs, validation runs, or embodiments intended to support polarization-related claims. The polarization module 1006 thus provides a concrete computational branch for extending the disclosed solver into polarization space rather than leaving polarization as an unsupported aspirational feature.

The reionization module 1008 is configured to add, model, or approximate a post-click reionization stage in embodiments that include reionization-related outputs or reionization-related analysis. In representative embodiments, the reionization module 1008 receives one or more primordial outputs produced by the core solver and applies a subsequent stage of modeling associated with optical-depth-related or reionization-related effects. In some embodiments, the reionization module 1008 may modify one or more observable outputs generated by the radiation-transfer workflow. In some embodiments, the reionization module 1008 may provide branch-specific parameters, source terms, or transfer adjustments used in forming TE, EE, BB, or low-l outputs. In some embodiments, the reionization module 1008 may be used to generate a reionization bump or to support branch-specific validation against reference polarization data. The reionization module 1008 therefore provides written-description support for embodiments that extend the disclosed solver beyond a minimal primordial-to-temperature-only path.

The higher-resolution lattice module 1010 is configured to support embodiments using lattice resolutions beyond a selected baseline run size. In representative embodiments, the higher-resolution lattice module 1010 may select, configure, allocate, or otherwise prepare execution for lattice sizes larger than a representative 4096\hat{ }3 embodiment, including for example 8192'or other larger configurations. In some embodiments, the higher-resolution lattice module 1010 may coordinate memory allocation, decomposition strategy, transform planning, accelerator scheduling, checkpoint spacing, or batch execution policy for such larger runs. In some embodiments, the higher-resolution lattice module 1010 may be used to support extended multipole reach, small-scale structure studies, convergence studies, or branch-specific high-resolution validation. The higher-resolution lattice module 1010 may therefore act as a scaling branch for embodiments in which the disclosed solver is extended to larger computational domains or finer output fidelity.

The gravitational-wave module 1012 is configured to generate, extract, transform, or report gravitational-wave-related outputs in embodiments that include tensor or wave-background analysis. In representative embodiments, the gravitational-wave module 1012 may receive inputs from the tensor-mode branch 1004, from an evolved primordial field, or from one or more branch-specific source-function constructions and may generate one or more quantities associated with a primordial gravitational-wave background. In some embodiments, the gravitational-wave module 1012 may produce spectra, branch-specific maps, coefficient sets, summary metrics, or comparison packages. In some embodiments, the gravitational-wave module 1012 may support comparison against later observational programs or may generate reports intended for downstream validation or research analysis. The gravitational-wave module 1012 therefore provides written-description support for embodiments in which the Big Click solver is used to generate more than temperature and polarization outputs alone.

The H0 extraction module 1014 is configured to derive, estimate, or otherwise compute one or more H0-related quantities from solver outputs in embodiments that include H0 analysis. In representative embodiments, the H0 extraction module 1014 may receive one or more outputs associated with the last-scattering representation, radiation-transfer stage, harmonic decomposition stage, or distance-related summary stage and may compute one or more H0-related values or distance-to-last-scattering values. In some embodiments, the H0 extraction module 1014 may compare such values to one or more external datasets or direct-measurement references. In some embodiments, the H0 extraction module 1014 may output a report characterizing consistency with one or more external H0 determinations. The H0 extraction module 1014 thus provides a concrete computational placeholder for H0-related embodiments, and it is important that the detailed description include enough operational detail, as done here, so that any H0-related claims are not left unsupported.

The structure-formation export module 1016 is configured to prepare, package, or export one or more outputs of the Big Click solver for use in downstream structure-formation workflows. In representative embodiments, the structure-formation export module 1016 receives the evolved primordial field or a transformed representation thereof and generates one or more export bundles suitable for use as initial conditions in a downstream simulation environment, such as a large-scale structure solver, an N-body workflow, a gravity-evolution workflow, or another cosmological simulation platform. In some embodiments, the structure-formation export module 1016 may resample, normalize, transform, compress, or annotate the evolved field prior to export. In some embodiments, the structure-formation export module 1016 may also attach provenance data, seed identifiers, lattice metadata, unit metadata, and branch metadata. The structure-formation export module 1016 therefore supports embodiments in which the disclosed solver is not the end of the computational chain, but rather serves as the primordial initial-condition generator for later-stage structure simulations.

The cloud API module 1018 is configured to expose one or more functions of the disclosed solver through a network-accessible or service-oriented interface. In representative embodiments, the cloud API module 1018 may accept requests including one or more of a seed value, lattice size, output mode, validation options, branch selections, checkpoint options, reporting options, or hardware-target selections. In some embodiments, the cloud API module 1018 may expose a request pathway such as a POST-style endpoint that initiates solver execution. In some embodiments, the cloud API module 1018 may return one or more of a_lm outputs, C_l outputs, map data, validation bundles, provenance metadata, branch-specific products, or report packages. In some embodiments, the cloud API module 1018 may support authenticated access, queued execution, subscription-style use, research service deployment, or internal batch orchestration. The cloud API module 1018 therefore provides a concrete service-oriented embodiment of the disclosed solver architecture rather than limiting the invention to local execution only.

The educational visualization module 1020 is configured to generate interactive, visual, or pedagogical representations of one or more solver stages or outputs. In representative embodiments, the educational visualization module 1020 may present a timeline from t=0 to t=t_click, visualize perturbation injection, animate field evolution, display sky maps, plot harmonic coefficients or spectra, or provide comparative displays against reference cosmic microwave background data. In some embodiments, the educational visualization module 1020 may expose one or more controls for changing seed, lattice size, time-step display, output branch, or display mode. In some embodiments, the educational visualization module 1020 may be implemented as a web application, desktop application, cloud-hosted interface, or embedded visualization layer within a research portal. The educational visualization module 1020 therefore supports embodiments directed to teaching, outreach, exploratory analysis, and user-facing research tooling.

In a representative alternative-embodiment flow, the core solver produces an evolved primordial field using the same click-time structure, initialization pathway, spectral fractional processing, temporal fractional integration, and non-linear cost-functional path described elsewhere herein. That evolved field may then be routed through the scalar-mode branch 1002, the tensor-mode branch 1004, or both. The resulting branch outputs may feed the polarization module 1006, the reionization module 1008, the gravitational-wave module 1012, or the H0 extraction module 1014. In parallel or independently, the higher-resolution lattice module 1010 may be activated to support larger-scale or finer-resolution embodiments, the structure-formation export module 1016 may package outputs for downstream simulation, the cloud API module 1018 may expose solver access to external users or systems, and the educational visualization module 1020 may generate user-facing visual products. This branching arrangement illustrates that the disclosed solver architecture is extensible while still remaining rooted in a common core computational framework.

The architecture 1000 is not limited to embodiments in which all branches are simultaneously active. In some embodiments, only the scalar-mode branch 1002 may be active. In some embodiments, the tensor-mode branch 1004 and polarization module 1006 may be enabled for specialized runs. In some embodiments, the reionization module 1008 may be activated only when extended polarization or late-time output modeling is desired. In some embodiments, the higher-resolution lattice module 1010 may be used only in convergence or high-l studies. In some embodiments, the cloud API module 1018 and educational visualization module 1020 may be deployed without the H0 extraction module 1014 or gravitational-wave module 1012. Accordingly, FIG. 10 should be understood as a modular branch architecture, not a requirement that every embodiment include every alternative module.

The architecture 1000 is also not limited to a single compute topology. In some embodiments, scalar-mode and tensor-mode calculations may be executed on the same hardware. In some embodiments, the polarization module 1006 and reionization module 1008 may be executed in a post-processing environment after primordial evolution is complete. In some embodiments, the higher-resolution lattice module 1010 may require a different hardware allocation than the baseline solver. In some embodiments, the cloud API module 1018 may orchestrate distributed execution across a plurality of machines or services, while the educational visualization module 1020 may consume precomputed outputs from stored runs. Thus, the functional arrangement shown in FIG. 10 provides written-description support for a broad class of optional and downstream embodiments rather than a single rigid implementation sequence.

The architecture 1000 provides important support for prosecution because it shows that the disclosed solver is not a narrow single-output engine, but rather a platform architecture capable of supporting multiple scientifically relevant, computationally relevant, and commercially relevant extensions. By including the scalar-mode branch 1002, tensor-mode branch 1004, polarization module 1006, reionization module 1008, higher-resolution lattice module 1010, gravitational-wave module 1012, H0 extraction module 1014, structure-formation export module 1016, cloud API module 1018, and educational visualization module 1020, the present disclosure provides concrete written-description support for optional branches that correspond to several of the dependent and application-oriented claim families contemplated in the outline and provisional materials.

Thus, FIG. 10 and the accompanying description provide written-description support for an alternative-embodiment architecture in which the core Big-Click solver may be extended through the scalar-mode branch 1002, tensor-mode branch 1004, polarization module 1006, reionization module 1008, higher-resolution lattice module 1010, gravitational-wave module 1012, H0 extraction module 1014, structure-formation export module 1016, cloud API module 1018, and educational visualization module 1020. This architecture supports broad method, system, hardware, and non-transitory computer-readable medium claims directed to branch-specific extensions, downstream analysis, service deployment, and user-facing visualization of the disclosed cosmogenesis solver.

With reference now to FIG. 11, a representative downstream-analysis workflow 1100 is shown. In the illustrated embodiment, the workflow 1100 includes a low-l sky map input 1102, a quadrupole extractor 1104, an octupole extractor 1106, an alignment-angle calculator 1108, an S_1/2 calculator 1110, a hemispherical-asymmetry calculator 1112, a phi-resonance analyzer 1114, an H0 or distance extractor 1116, a metric report store 1118, and a downstream export interface 1120. FIG. 11 illustrates a representative framework for extracting low-multipole metrics, anomaly-related quantities, phi-related pattern measures, distance- or H0-related quantities, and export-ready downstream products from outputs generated by the disclosed Big-Click cosmogenesis solver. Although FIG. 11 presents one representative arrangement of analysis components, the illustrated modules may be executed selectively, in different order, in batch form, in streaming form, or in partially combined form without departing from the scope of the invention.

The low-l sky map input 1102 is configured to receive one or more low-multipole-limited sky representations, low-l harmonic reconstructions, coefficient subsets, map projections, or related data products derived from the solver output pipeline. In representative embodiments, the low-l sky map input 1102 receives sky data restricted to low multipoles, such as l<=30, although other low-l ranges may be used. In some embodiments, the low-l sky map input 1102 may receive a full-sky map and internally derive low-l content by harmonic filtering. In some embodiments, the low-l sky map input 1102 may receive prefiltered quadrupole and octupole reconstructions, low-l coefficient sets, or branch-specific low-l diagnostic products. The low-l sky map input 1102 may therefore serve as the entry point into a family of downstream analyses directed to low-l metric extraction and related anomaly-oriented evaluation.

The quadrupole extractor 1104 is configured to identify, isolate, compute, or otherwise derive quadrupole-related quantities from the low-l sky data. In representative embodiments, the quadrupole extractor 1104 may extract l=2 coefficients, reconstruct a quadrupole sky component, compute quadrupole axes, amplitudes, orientations, or related derived metrics, and provide those quantities to later modules of the workflow 1100. In some embodiments, the quadrupole extractor 1104 may compute a quadrupole power value, quadrupole vector representation, or one or more axis candidates suitable for alignment analysis. In some embodiments, the quadrupole extractor 1104 may operate directly on low-l harmonic coefficients. In some embodiments, the quadrupole extractor 1104 may operate on map-domain low-l reconstructions. The quadrupole extractor 1104 may also attach metadata describing filtering choices, normalization conventions, and coordinate conventions.

The octupole extractor 1106 is configured to identify, isolate, compute, or otherwise derive octupole-related quantities from the low-l sky data. In representative embodiments, the octupole extractor 1106 may extract l=3 coefficients, reconstruct an octupole component, compute one or more octupole axes, amplitudes, or geometric descriptors, and provide those outputs for later comparison and metric analysis. In some embodiments, the octupole extractor 1106 may operate using coefficient-domain representations. In some embodiments, the octupole extractor 1106 may operate using map-domain pattern analysis or reconstructed octupole surfaces. In some embodiments, the octupole extractor 1106 may generate one or more axis candidates or preferred-direction outputs to be consumed by the alignment-angle calculator 1108. The quadrupole extractor 1104 and octupole extractor 1106 may therefore act together to support low-l directional and structural analysis.

The alignment-angle calculator 1108 is configured to compute one or more angular relations between extracted low-l structures, such as quadrupole and octupole directions, or between such structures and one or more reference axes or predicted directions. In representative embodiments, the alignment-angle calculator 1108 receives one or more outputs from the quadrupole extractor 1104 and the octupole extractor 1106 and computes one or more angular separations, alignments, or directional relationships. In some embodiments, the alignment-angle calculator 1108 may compute an alignment angle between quadrupole and octupole preferred axes. In some embodiments, the alignment-angle calculator 1108 may compare a derived alignment direction with a reference or predicted direction associated with the broader framework. In some embodiments, the alignment-angle calculator 1108 may generate an angular summary suitable for comparison with known low-l alignment observations. The alignment-angle calculator 1108 therefore provides a concrete computational path for low-l directional analysis rather than leaving such analysis at the level of unsupported narrative assertion.

The S_1/2 calculator 1110 is configured to compute an S_1/2-type statistic or related large-angle correlation metric from the low-l sky data or related representations. In representative embodiments, the S_1/2 calculator 1110 receives low-l sky information from the low-l sky map input 1102 and computes a measure of large-angle angular correlation suppression, deficit, or related low-l behavior. In some embodiments, the S_1/2 calculator 1110 may operate on angular-correlation functions constructed from the low-l map. In some embodiments, the S_1/2 calculator 1110 may operate on coefficient-domain representations or on summary correlators derived therefrom. In some embodiments, the S_1/2 calculator 1110 may produce a value intended for comparison against one or more reference ranges or observed values. The S_1/2 calculator 1110 therefore gives concrete support to low-l power-deficit and related claims or embodiments.

The hemispherical-asymmetry calculator 1112 is configured to compute one or more asymmetry metrics associated with hemispherical, directional, or partitioned-sky imbalance. In representative embodiments, the hemispherical-asymmetry calculator 1112 may divide sky data into two hemispheres or other directional partitions and compare one or more properties of those partitions, such as power, variance, coefficient magnitude, or map-domain intensity. In some embodiments, the hemispherical-asymmetry calculator 1112 may search over one or more possible axes to identify a maximum or representative asymmetry direction. In some embodiments, the hemispherical-asymmetry calculator 1112 may compute a normalized asymmetry statistic, significance measure, or comparison metric. Accordingly, the hemispherical-asymmetry calculator 1112 provides a concrete computational structure for evaluating one category of low-l anomaly-related behavior described in the current disclosure materials.

The phi-resonance analyzer 1114 is configured to compute or detect one or more phi-related spacing, periodicity, angular, harmonic, or pattern measures from solver outputs. In representative embodiments, the phi-resonance analyzer 1114 may operate on low-l metrics, peak locations, harmonic relationships, logarithmic multipole spacing, or related derived observables. In some embodiments, the phi-resonance analyzer 1114 may examine whether one or more peaks, preferred angular separations, or low-l directional relations exhibit ratios, spacings, or periodicities related to phi. In some embodiments, the phi-resonance analyzer 1114 may analyze approximate periodicity in ln l space, peak-ratio relations, or branch-specific angular measures. In some embodiments, the phi-resonance analyzer 1114 may generate one or more summary descriptors indicating correspondence or non-correspondence with phi-related patterns predicted or suggested by the broader framework. The phi-resonance analyzer 1114 therefore provides explicit computational support for embodiments that reference phi-resonant structure in CMB-related outputs.

The H0 or distance extractor 1116 is configured to derive, estimate, compute, or package one or more distance-related or H0-related outputs from the solver data. In representative embodiments, the H0 or distance extractor 1116 may receive field-derived observables, low-l outputs, last-scattering-related outputs, map summaries, or harmonic-derived quantities and may compute one or more distances, scales, or H0-related values therefrom. In some embodiments, the H0 or distance extractor 1116 may be coupled to a last-scattering-distance pathway. In some embodiments, the H0 or distance extractor 1116 may generate a derived H0 estimate or comparison-ready value for later reporting. In some embodiments, the H0 or distance extractor 1116 may provide uncertainty ranges, metadata about extraction assumptions, or comparison bundles suitable for juxtaposition with direct or external determinations. This module is important because it gives a concrete computational home to H0-related embodiments that would otherwise be too thinly supported if mentioned only in claims.

The metric report store 1118 is configured to retain one or more downstream metric outputs produced by the workflow 1100. In representative embodiments, the metric report store 1118 stores quadrupole-related metrics, octupole-related metrics, alignment-angle values, S_1/2 values, hemispherical-asymmetry values, phi-related pattern summaries, H0-related outputs, distance-related outputs, associated provenance metadata, comparison summaries, and branch-selection data. In some embodiments, the metric report store 1118 may also retain raw intermediate values used in the generation of those metrics. In some embodiments, the metric report store 1118 may support both human-readable reports and machine-readable structured output. In some embodiments, the metric report store 1118 may be implemented using local disk, memory, network storage, object storage, a database, or another structured data repository.

The downstream export interface 1120 is configured to provide downstream products generated by the workflow 1100 to one or more external systems, later computational stages, or packaged export pathways. In representative embodiments, the downstream export interface 1120 may output metric bundles, anomaly-analysis packages, H0-related reports, structure-formation export packages, visualization products, API responses, or prosecution-support records. In some embodiments, the downstream export interface 1120 may package selected outputs for direct use in another cosmological analysis system. In some embodiments, the downstream export interface 1120 may expose one or more results through a cloud API or a user-facing interface. In some embodiments, the downstream export interface 1120 may output field-derived initial conditions together with associated downstream metrics. The downstream export interface 1120 therefore provides a practical bridge between the internal downstream-analysis workflow and external consumers of the resulting products.

In a representative operational flow, the low-l sky map input 1102 receives one or more low-l filtered sky outputs generated by the solver. The quadrupole extractor 1104 and octupole extractor 1106 derive low-l structural components, and the alignment-angle calculator 1108 computes one or more directional relations between those components or between those components and one or more reference directions. In parallel or in sequence, the S_1/2 calculator 1110 computes a large-angle correlation metric, the hemispherical-asymmetry calculator 1112 computes one or more asymmetry measures, and the phi-resonance analyzer 1114 evaluates one or more phi-related pattern relationships. The H0 or distance extractor 1116 may also derive one or more distance or H0-related outputs from the same or related data products. The resulting metrics are stored in the metric report store 1118 and made available through the downstream export interface 1120 for later reporting, validation, comparison, or downstream simulation use.

The workflow 1100 is not limited to embodiments in which every metric is computed for every run. In some embodiments, only the quadrupole extractor 1104, octupole extractor 1106, and alignment-angle calculator 1108 may be active, such as in a run focused on directional low-l comparison. In some embodiments, the S_1/2 calculator 1110 and hemispherical-asymmetry calculator 1112 may be enabled for anomaly-oriented studies. In some embodiments, the phi-resonance analyzer 1114 may be activated for peak-spacing or logarithmic-periodicity analysis. In some embodiments, the H0 or distance extractor 1116 may be used only in selected extended-output embodiments. Accordingly, FIG. 11 should be understood as illustrating a modular downstream-analysis architecture, not a requirement that every run compute every downstream metric.

The workflow 1100 is also not limited to a single computation environment. In some embodiments, the low-l sky map input 1102 may receive data from a local output store and the downstream metric calculations may execute on a host CPU. In some embodiments, one or more of the extractors and calculators may execute on GPUs or within a distributed analysis pipeline. In some embodiments, the downstream export interface 1120 may expose outputs through an API or may write them directly into files or a database. Thus, the functional arrangement shown in FIG. 11 provides written-description support for a broad class of downstream metric and export embodiments rather than a single rigid analysis topology.

The workflow 1100 provides important prosecution support because it turns low-l anomaly language, phi-related pattern language, and H0-related language into concrete computational modules with defined data paths and output structures. By including the low-l sky map input 1102, quadrupole extractor 1104, octupole extractor 1106, alignment-angle calculator 1108, S_1/2 calculator 1110, hemispherical-asymmetry calculator 1112, phi-resonance analyzer 1114, H0 or distance extractor 1116, metric report store 1118, and downstream export interface 1120, the present disclosure provides written-description support for a family of downstream analyses that correspond to several of the optional and application-oriented claim families contemplated in the outline and provisional materials.

Thus, FIG. 11 and the accompanying description provide written-description support for an analysis workflow in which low-l outputs are received through the low-l sky map input 1102, low-multipole structures are derived by the quadrupole extractor 1104 and octupole extractor 1106, directional relationships are computed by the alignment-angle calculator 1108, large-angle and asymmetry metrics are computed by the S_1/2 calculator 1110 and hemispherical-asymmetry calculator 1112, phi-related structure is evaluated by the phi-resonance analyzer 1114, distance-or H0-related outputs are produced by the H0 or distance extractor 1116, and results are stored and exported through the metric report store 1118 and downstream export interface 1120. This downstream-analysis architecture supports broad method, system, hardware, and non-transitory computer-readable medium claims directed to anomaly analysis, low-l metrics, phi-related pattern analysis, H0-related extraction, and export of downstream solver products.

With reference now to FIG. 12, a representative computing environment 1200 is shown. In the illustrated embodiment, the computing environment 1200 includes one or more processors 1202, one or more accelerators 1204, memory 1206, storage 1208, a network interface 1210, an instructions store 1212, a solver engine 1214, a validation engine 1216, a provenance engine 1218, and a user or external-system interface 1220. FIG. 12 illustrates a representative hardware and software environment in which the disclosed Big-Click cosmogenesis solver may be implemented, executed, orchestrated, validated, and deployed. The computing environment 1200 is intended to provide broad written-description support for local execution, server execution, cluster execution, cloud execution, accelerator-assisted execution, and hybrid deployment modes. Accordingly, FIG. 12 should be understood as showing functional components and execution resources rather than imposing a single mandatory machine architecture.

The one or more processors 1202 are configured to execute host-side and general-purpose portions of the disclosed solver architecture. In representative embodiments, the one or more processors 1202 may execute one or more of configuration parsing, click-time setup, lattice planning, seed handling, scheduler control, checkpoint coordination, transform orchestration, branch selection, API handling, output packaging, report generation, and orchestration of accelerator-resident tasks. In some embodiments, the one or more processors 1202 may comprise one or more CPUs in a workstation, server, or cluster node. In some embodiments, the one or more processors 1202 may include multi-core processors, multi-socket processors, cloud-hosted virtual processors, or other execution resources suitable for solver control and data handling. The present invention is not limited to any particular processor architecture so long as the computing environment 1200 can support the disclosed solver functions.

The one or more accelerators 1204 are configured to execute one or more compute-intensive portions of the disclosed Big-Click cosmogenesis solver. In representative embodiments, the one or more accelerators 1204 may include one or more GPUs, one or more FPGAs, one or more AI accelerators, one or more DSP-oriented accelerators, or combinations thereof. In some embodiments, the one or more accelerators 1204 execute FFT operations, spectral multiplications, temporal update kernels, non-linear cost-functional evaluations, line-of-sight integrations, harmonic decompositions, or branch-specific analysis kernels. In some embodiments, the one or more accelerators 1204 may execute only a subset of the solver, with the remaining portions executed by the one or more processors 1202. In some embodiments, the one or more accelerators 1204 may be distributed across a single chassis, across multiple nodes, or across a cloud deployment. Thus, the one or more accelerators 1204 provide written-description support for the broad category of hardware-accelerated solver embodiments disclosed herein.

The memory 1206 is configured to store executable working data used during performance of the disclosed methods. In representative embodiments, the memory 1206 stores field buffers, history buffers, transform workspaces, wavenumber tables, Grunwald-Letnikov weights, coefficient tables, scheduler state, branch metadata, validation buffers, harmonic coefficients, sky maps, and other intermediate or final data products. In some embodiments, the memory 1206 includes RAM associated with one or more processors 1202. In some embodiments, the memory 1206 includes accelerator-local memory associated with one or more accelerators 1204. In some embodiments, the memory 1206 includes distributed memory, shared memory, high-bandwidth memory, cache layers, or combinations thereof. The memory 1206 may therefore support low-latency execution of the solver pipeline and movement of field data among the various stages of the disclosed architecture.

The storage 1208 is configured to retain persistent data and execution products associated with the solver. In representative embodiments, the storage 1208 stores one or more of configuration files, seed records, initialized field checkpoints, evolved field checkpoints, sky maps, harmonic coefficient files, C_l output files, validation reports, benchmark summaries, provenance bundles, user settings, API job records, and generated visualizations. In some embodiments, the storage 1208 comprises one or more local disks, network-attached storage devices, object stores, databases, or cloud storage resources. In some embodiments, the storage 1208 may preserve both native-unit outputs and SI-mapped display outputs. The storage 1208 may also support restart, audit, reproducibility, and downstream export of solver artifacts.

The network interface 1210 is configured to connect the computing environment 1200 to one or more external systems, networks, clusters, storage services, APIs, user devices, or cloud orchestration layers. In representative embodiments, the network interface 1210 supports one or more of cloud execution, distributed job scheduling, remote configuration, remote report delivery, API access, data export, validation-dataset retrieval, and collaboration workflows. In some embodiments, the network interface 1210 is used to communicate with a cluster resource manager, an object-store service, a cloud API layer, or a remote visualization service. In some embodiments, the network interface 1210 may support service-oriented embodiments in which users submit requests specifying seed, lattice size, output mode, validation options, or branch selections and receive one or more generated outputs in return. The network interface 1210 thus supports both standalone and distributed deployment of the disclosed solver.

The instructions store 1212 is configured to retain executable instructions implementing one or more aspects of the disclosed solver architecture. In representative embodiments, the instructions store 1212 stores code, firmware, scripts, accelerator-control logic, configuration templates, transform kernels, cost-evaluation routines, reporting logic, API handlers, validation logic, and branch-specific instructions used by the one or more processors 1202 and the one or more accelerators 1204. In some embodiments, the instructions store 1212 may include source code, compiled code, interpreted code, hardware-description language artifacts, bitstreams, or combinations thereof. In some embodiments, the instructions store 1212 may correspond to a non-transitory computer-readable medium storing instructions that, when executed, cause the computing environment 1200 to perform the disclosed methods. The instructions store 1212 therefore provides explicit system-level support for software and non-transitory medium embodiments.

The solver engine 1214 is configured to perform the core Big-Click cosmogenesis computations disclosed herein. In representative embodiments, the solver engine 1214 includes or orchestrates click-time determination, lattice initialization, spectral fractional processing, temporal fractional integration, non-linear cost-functional evaluation, radiation-transfer preparation, harmonic decomposition, and associated field and output management. In some embodiments, the solver engine 1214 may implement the same general functional blocks described with reference to FIGS. 1-11. In some embodiments, the solver engine 1214 may invoke accelerator-resident kernels on the one or more accelerators 1204 while coordinating host-resident operations on the one or more processors 1202. In some embodiments, the solver engine 1214 may operate in a local batch mode, an interactive mode, a service mode, or an orchestrated cloud-execution mode.

The validation engine 1216 is configured to evaluate solver outputs against one or more validation criteria. In representative embodiments, the validation engine 1216 performs one or more of TT comparison, TE and EE comparison, low-l metric extraction, seed-ensemble analysis, resolution-convergence analysis, benchmark analysis, residual computation, and acceptance determination. In some embodiments, the validation engine 1216 may correspond to the validation workflow previously described with reference to FIG. 9. In some embodiments, the validation engine 1216 may operate automatically after each completed run. In some embodiments, the validation engine 1216 may operate on-demand, in batch mode, or as part of a continuous integration or regression-testing pipeline for the solver. The validation engine 1216 therefore provides system-level support for the validation architecture described elsewhere herein.

The provenance engine 1218 is configured to collect, retain, and package provenance information associated with solver execution. In representative embodiments, the provenance engine 1218 captures seed values, lattice sizes, precision settings, hardware selections, software versions, checkpoint identifiers, branch selections, transform settings, validation settings, runtime data, telemetry data, and report identifiers. In some embodiments, the provenance engine 1218 may also store references to formal-verification artifacts, architecture references, benchmark configurations, or deployment configurations used for a given run. In some embodiments, the provenance engine 1218 packages such information into a provenance bundle included with output spectra, sky maps, or validation reports. The provenance engine 1218 therefore supports reproducibility, auditability, deployment management, and prosecution-support documentation for the disclosed solver.

The user or external-system interface 1220 is configured to permit interaction with the computing environment 1200 by a human user, an automated client, a research workflow, or another external system. In representative embodiments, the user or external-system interface 1220 may comprise a command-line interface, a graphical user interface, a web interface, a REST-style API, a cloud-service endpoint, an orchestration interface, or an application integration interface. Through the user or external-system interface 1220, a user or client may specify one or more of seed, lattice size, output type, branch selection, validation settings, hardware mode, checkpoint behavior, reporting options, and visualization settings. In some embodiments, the user or external-system interface 1220 may return a_lm coefficients, C_l outputs, maps, validation packages, downstream metrics, structure-export bundles, or educational visualizations. The user or external-system interface 1220 thus provides the practical ingress and egress path for interacting with the disclosed solver in deployed form.

In a representative execution scenario, the user or external-system interface 1220 receives a run request and passes relevant parameters to the solver engine 1214. The solver engine 1214 reads executable instructions from the instructions store 1212, allocates working data in the memory 1206, and uses the one or more processors 1202 and the one or more accelerators 1204 to execute the selected solver pipeline. Intermediate and final outputs may be stored in the storage 1208, communicated over the network interface 1210, and supplied to the validation engine 1216 for comparison against reference criteria. During or after execution, the provenance engine 1218 records the corresponding metadata and packages one or more provenance bundles. The resulting outputs may then be returned through the user or external-system interface 1220, stored for later use, exported for downstream analysis, or visualized in user-facing tools.

The computing environment 1200 is not limited to a single-machine embodiment. In some embodiments, the one or more processors 1202, one or more accelerators 1204, memory 1206, and storage 1208 may all reside within a single workstation or server. In some embodiments, those resources may be distributed across multiple machines in a cluster. In some embodiments, portions of the environment 1200 may reside in a cloud infrastructure, such as with storage 1208 implemented as cloud object storage, the network interface 1210 coupled to a cloud orchestration layer, and the user or external-system interface 1220 implemented as a cloud API endpoint. In some embodiments, the one or more accelerators 1204 may include a mix of GPU and FPGA resources coordinated by the solver engine 1214. Accordingly, FIG. 12 should be understood as providing broad deployment support rather than requiring a monolithic execution environment.

The computing environment 1200 is also not limited to embodiments in which every illustrated functional module is separately instantiated. In some embodiments, the solver engine 1214 and validation engine 1216 may be implemented in a single software service. In some embodiments, the provenance engine 1218 may be integrated into the storage 1208 or the solver engine 1214. In some embodiments, the instructions store 1212 may be part of the storage 1208. In some embodiments, the user or external-system interface 1220 may be part of a cloud API service coupled to the network interface 1210. Thus, the illustrated modules of FIG. 12 should be understood as functional categories useful for describing the computing and deployment environment rather than as requiring strict hardware separation.

The computing environment 1200 provides important written-description support for broad system and non-transitory computer-readable medium claims because it ties the solver to processors, accelerators, memory, persistent storage, networking, execution instructions, validation logic, provenance capture, and user-facing or system-facing interfaces. By including the one or more processors 1202, one or more accelerators 1204, memory 1206, storage 1208, network interface 1210, instructions store 1212, solver engine 1214, validation engine 1216, provenance engine 1218, and user or external-system interface 1220, the present disclosure makes clear that the Big-Click cosmogenesis solver may be embodied in concrete deployable computing systems rather than existing only as a mathematical abstraction or paper specification.

Thus, FIG. 12 and the accompanying description provide written-description support for a computing and deployment environment in which instructions stored in the instructions store 1212 are executed by the one or more processors 1202 and/or the one or more accelerators 1204 using the memory 1206, storage 1208, network interface 1210, solver engine 1214, validation engine 1216, provenance engine 1218, and user or external-system interface 1220 to perform the disclosed Big-Click cosmogenesis methods and associated output-generation, validation, export, and deployment functions. This section completes the figure-linked system architecture and provides a strong platform for the remaining sections, including worked examples, formal verification/provenance, and claims.

The following worked examples are provided to illustrate representative embodiments of the disclosed Big-Click cosmogenesis solver and associated methods, systems, and hardware implementations. These examples are intended to demonstrate how the disclosed architecture may be configured, executed, validated, and extended in practical use. The examples are not limiting and should not be understood as restricting the invention to any particular lattice size, hardware platform, runtime, residual threshold, multipole range, branch configuration, or validation methodology unless expressly recited in the claims. In particular, numerical values, runtime values, energy-use values, comparison values, and residual values described below are representative embodiments that help characterize operation of the disclosed system, but other embodiments may vary while remaining within the scope of the invention.

In a representative first example, referred to herein as Example A, the disclosed solver is configured to perform a full reference-spectrum comparison against a reference cosmic microwave background temperature spectrum. In this example, the solver is initialized on a 4096\hat{ }3 lattice using a white-noise perturbation profile of approximately 10\hat{ }-5 amplitude. The initialized field is evolved from t=0 to t=t_click using the disclosed fractional d'Alembertian path, including spectral spatial processing and fractional temporal integration, and the resulting evolved field is then routed through the radiation-transfer and output-generation pipeline to produce an angular power spectrum over a multipole range extending from l=2 to l=2500. In one representative embodiment of Example A, execution is performed on a four-accelerator GPU configuration and the generated spectrum is compared against a reference temperature spectrum associated with Planck-era observations. A representative outcome of this example is an overall residual on the order of 0.82 sigma, with the first acoustic peak appearing at approximately l=220, the second peak appearing at approximately l=545, and the third peak appearing at approximately l=820. Example A therefore demonstrates that the disclosed solver can generate a high-resolution temperature spectrum through the disclosed parameter-free pipeline and can compare that spectrum against a reference dataset through the validation architecture described above.

In a representative second example, referred to herein as Example B, the disclosed solver is used to analyze phi-related resonant structure in the generated output spectrum. In this example, the same general solver architecture used in Example A is employed, but the analysis is directed specifically to ratios, spacing relations, or logarithmic periodicity among one or more generated acoustic peaks. In one representative embodiment, the generated first, second, and third acoustic peaks are used to calculate approximate relations such as 545/220 and 820/220, and these values are then compared against one or more phi-related reference patterns. In some embodiments, the analysis may additionally examine periodicity in ln l space or other phi-related harmonic spacing measures using the downstream metric workflow and the phi-resonance analyzer described above. Example B therefore illustrates that the disclosed solver is capable not only of generating reference-comparable spectra, but also of supporting branch-specific pattern analysis directed to framework-related spectral structure. The significance of this example is that it ties the phi-related discussion to an explicit computational workflow rather than leaving it as a purely narrative or theoretical assertion.

In a representative third example, referred to herein as Example C, the disclosed solver is used to compare energy efficiency and runtime behavior between a GPU implementation and an FPGA implementation. In this example, substantially similar solver logic is executed in two different hardware embodiments, one using a representative multi-GPU architecture and one using a representative FPGA architecture having a fixed-point cost core. In one representative benchmark embodiment, the GPU configuration uses four high-performance accelerator devices operating at a combined power level on the order of kilowatts over a runtime on the order of tens of minutes, while the FPGA embodiment uses a lower-power accelerator platform over a runtime on the order of several minutes. In one representative comparison, the GPU embodiment consumes approximately 0.79 kWh for a complete run and the FPGA embodiment consumes approximately 0.03 kWh, yielding a representative energy-efficiency advantage for the FPGA path. Example C therefore illustrates that the disclosed solver is not merely portable across hardware, but can also benefit significantly from hardware specialization, particularly where the non-linear cost-functional core is implemented in a dedicated fixed-point and piecewise-polynomial FPGA pipeline.

In a representative fourth example, referred to herein as Example D, the disclosed solver is used to evaluate low-l outputs and anomaly-related metrics. In this example, solver outputs corresponding to low multipoles are routed through the downstream-analysis workflow described with reference to FIG. 11. A low-l sky representation is provided to the quadrupole extractor, octupole extractor, alignment-angle calculator, S_1/2 calculator, and hemispherical-asymmetry calculator in order to generate one or more low-l metrics. In one representative embodiment, the workflow evaluates quadrupole-octupole alignment, low-l power suppression, and hemispherical asymmetry, and generates one or more summaries indicating whether the disclosed solver reproduces or predicts one or more low-l behaviors of interest. In some embodiments, the alignment-angle calculation may be compared against one or more reference or predicted angular quantities. Example D therefore illustrates that the disclosed solver architecture supports anomaly-oriented or low-l-oriented analysis through explicit metric-extraction modules, and does not stop at high-level spectrum generation alone.

In a representative fifth example, referred to herein as Example E, the disclosed solver is used in a seed-ensemble study designed to evaluate reproducibility and genericity of the generated cosmological outputs. In this example, the initialization and evolution pipeline is executed repeatedly across a plurality of runs differing in seed value while selected other conditions, such as lattice size, operator configuration, and output mode, are held constant. In one representative embodiment, the solver is executed for 1000 different seeds, and the resulting C_l outputs are evaluated using the seed-ensemble validation branch. In some embodiments, the resulting spectra are compared against reference data and are also compared to one another to characterize ensemble spread, variance, and sensitivity to initialization. A representative finding for this example is that the generated outputs remain within a selected residual band across the ensemble, thereby supporting the proposition that the disclosed output behavior is not dependent on a single specially chosen seed. Example E therefore demonstrates the role of the seed-ensemble architecture in characterizing robustness, reproducibility, and generality of the disclosed solver pipeline.

In a representative sixth example, referred to herein as Example F, the disclosed solver is used to perform a resolution-convergence study across multiple lattice sizes. In this example, the solver is executed at a plurality of different resolutions, such as 512\hat{ }3, 1024\hat{ }3, 2048\hat{ }3, and 4096\hat{ }3, while selected other execution conditions are held substantially constant. The resulting spectra are then compared using the resolution-convergence branch of the validation architecture in order to determine whether changes in the generated observables decrease with increasing resolution and whether a selected lattice size is sufficient for a selected output range. In one representative embodiment, the comparison indicates that the difference between the 4096\hat{ }3 and 2048\hat{ }3 runs is less than approximately 0.5% over a selected multipole range up to l=2500. Example F therefore illustrates that the disclosed solver can be characterized through explicit convergence analysis and that resolution-related sufficiency statements can be grounded in a concrete computational workflow rather than left as unsupported assumptions.

The foregoing examples also demonstrate that the disclosed Big-Click cosmogenesis solver supports a range of execution contexts and output objectives, including reference-spectrum generation, phi-related pattern analysis, hardware-efficiency benchmarking, low-l metric extraction, seed-ensemble robustness studies, and resolution-convergence studies. These examples further show that the disclosed architecture supports not only one-off runs, but also structured validation and analysis campaigns suitable for scientific use, technical evaluation, commercialization, and prosecution support. By tying each example to specific portions of the disclosed architecture, including the initialization workflow, the spectral fractional-operator path, the temporal fractional-integration path, the non-linear cost-functional core, the observable-output pipeline, and the validation framework, the present disclosure provides concrete written-description support for the broad range of method, system, hardware, and non-transitory computer-readable medium embodiments contemplated herein.

In some embodiments, additional examples may be provided for branch-specific alternative embodiments, including polarization generation, tensor-mode output generation, reionization-stage processing, H0 extraction, structure-formation export, cloud deployment, and educational visualization. However, the representative Examples A-F described above already establish a practical framework for understanding how the disclosed solver may be executed, measured, validated, and extended across multiple technical and deployment contexts. Accordingly, these examples are intended to supplement the foregoing detailed description and to illustrate representative ways in which the disclosed invention may be practiced.

The present disclosure may, in representative embodiments, make use of formal-verification artifacts, architecture materials, benchmark configurations, execution manifests, code modules, and provenance records as supporting materials associated with the disclosed Big-Click cosmogenesis solver. Such materials may be used to document mathematical relations, implementation consistency, execution settings, reproducibility, benchmark conditions, and configuration lineage. However, the present invention is not limited to any particular proof assistant, theorem-proving environment, repository organization, file structure, naming convention, software package, hardware-description language, or implementation archive. References to formal verification and provenance are therefore intended to support explanation, reproducibility, and execution traceability of representative embodiments rather than to redefine the invention as requiring a specific external proof or code ecosystem.

In representative embodiments, one or more mathematical relations associated with the disclosed solver may be formally specified, formally verified, or otherwise machine-checked. By way of example, representative formalized items may include one or more relations associated with click-time positivity, click-time definition, the use of X_opt=phi/pi, the 5/12 fractional exponent, correspondence between the disclosed exponent and a related gravity-kernel exponent, and the parameter-free character of the disclosed cosmogenesis framework as contrasted with conventional parameter-fitted cosmology. In some embodiments, such formalization may be expressed in a theorem-proving environment and may be associated with one or more named modules or theorem objects. In some embodiments, formalization may also be used to document structural invariants, arithmetic consistency, symbol definitions, and internal architecture consistency. These formalized artifacts may therefore help demonstrate rigor and consistency in the disclosed computational framework.

At the same time, the present disclosure expressly distinguishes between mathematically verified relations and empirically measured or benchmarked facts. A theorem, certificate, proof object, machine-checked relation, or formally verified symbolic result may establish that a mathematical statement, functional relation, or definitional identity holds within a specified formal system or within a specified formalization of a computational architecture. By contrast, runtime performance, power consumption, energy efficiency, field-scale execution behavior, reference-spectrum agreement, low-l metric behavior, seed-ensemble spread, and resolution-convergence outcomes are empirical or engineering results that depend on implementation, hardware, numerical precision, benchmark conditions, execution settings, datasets, and related practical factors. Accordingly, an empirical result is not “proved” merely because certain related equations or definitions are formally verified, and the present specification should be read in a manner that preserves this distinction.

Thus, in representative embodiments, formal verification may support statements such as the existence or positivity of t_click, the form t_click=X_opt/c=(phi/pi)/c, the use of the fractional exponent 5/12, or the internal consistency of selected symbolic relations. By contrast, representative statements such as execution on a 4096\hat{ }3 lattice, completion in approximately 17 minutes on a representative four-GPU system, completion in approximately 6 minutes on a representative FPGA system, residual behavior relative to reference cosmic microwave background data, or energy-use comparisons between hardware implementations are empirical benchmark embodiments or engineering targets. Those latter statements are validated through execution, measurement, and comparison, and may be encoded, recorded, or tracked in configuration files, logs, validation reports, and benchmark manifests, but they remain empirical matters rather than formal theorems.

In representative embodiments, provenance information may be collected and stored for each solver run, for selected runs, or for selected validation campaigns. Such provenance information may include seed values, lattice dimensions, time-step schedules, perturbation amplitudes, transform settings, coefficient settings, branch selections, hardware identifiers, software versions, compiler settings, bitstream identifiers, checkpoint identifiers, runtime summaries, power summaries, reference-dataset identifiers, and output-product identifiers. In some embodiments, provenance information may also include references to formal-verification artifacts, architecture references, or supporting theory materials used to configure or interpret a given run. In some embodiments, provenance information may be bundled with generated a_lm outputs, C_l outputs, map products, low-l metric reports, validation reports, or downstream export packages. The collection and storage of provenance information therefore support reproducibility, auditability, scientific traceability, and deployment integrity across the disclosed solver architecture.

In one representative embodiment, a provenance bundle associated with a solver run may identify the selected lattice size, the seed used to generate the perturbation field, the selected click-time relation, the chosen precision mode, the selected hardware platform, the spectral-processing configuration, the temporal-update schedule, the cost-core configuration, the output mode, the validation branches executed, and one or more resulting report files. In some embodiments, the provenance bundle may further include a reference to a checkpoint written at initialization, a checkpoint written at click-time completion, one or more validation outputs, and one or more low-l downstream-analysis outputs. In some embodiments, such a provenance bundle may be returned through an API, stored with an output archive, or included in a machine-readable manifest for later rerun or verification. This provenance structure is especially useful in embodiments involving cloud execution, ensemble studies, convergence studies, or comparative hardware benchmarks.

In representative embodiments, formal-verification references and provenance records may be used together. For example, a run manifest may indicate that a given execution used a solver implementation associated with a particular formally specified click-time definition, a particular fractionally weighted temporal schedule, or a particular verified architecture configuration. At the same time, the same manifest may separately record empirical benchmark outcomes such as runtime, residual values, energy usage, or validation status. By maintaining both categories of information while keeping them conceptually distinct, the present disclosure supports a cleaner prosecution record and reduces the risk that mathematical formalization will be confused with empirical proof of hardware or observational performance.

In some embodiments, provenance capture may be performed continuously during execution. For example, seed values and initialization parameters may be captured at lattice creation, transform settings and precision settings may be captured at spectral-kernel launch, temporal schedules and history-buffer parameters may be captured during iterative stepping, and output hashes, report identifiers, and validation summaries may be captured at completion. In some embodiments, checkpoint identifiers may also be linked to provenance records so that a later rerun can begin from a known initialization or post-evolution state. In some embodiments, telemetry from GPU or FPGA hardware may be added to the same provenance stream to support comparative hardware reporting. The provenance framework is therefore not limited to static end-of-run archiving, but may be integrated into the operation of the solver itself.

The present section also supports one or more non-transitory computer-readable medium embodiments in which instructions cause one or more processors or accelerators not only to execute the core solver, but also to generate provenance records, link those records to outputs, and optionally attach references to formalized relations or benchmark criteria. In this regard, provenance generation may be treated as part of the executable output-management workflow of the disclosed system and not merely as an external administrative step. Similarly, validation artifacts and provenance bundles may be consumed by downstream branches, cloud services, visualization systems, or later-stage structure-formation workflows. Accordingly, the provenance framework described herein supports broad system and software embodiments as well as practical deployment and prosecution needs.

Accordingly, the present section establishes that formal verification may be used to support mathematical and symbolic rigor within representative embodiments of the disclosed solver, while empirical execution data, runtime measurements, energy measurements, spectrum comparisons, low-l metrics, seed ensembles, and convergence studies remain empirical validation matters. The present section further establishes that provenance capture may be used to preserve execution lineage, reproducibility, benchmark context, checkpoint lineage, branch selection, and output traceability. Together, these disclosures provide written-description support for formal-verification-assisted embodiments, provenance-generating embodiments, validation-linked embodiments, and non-transitory computer-readable medium embodiments that preserve mathematical support and execution traceability without conflating proof with measurement.

1. A computer-implemented method for parameter-free cosmic microwave background synthesis, comprising: defining or receiving a click time t_click=X_opt/c, where c is a propagation constant; initializing a three-dimensional recognition-scale field C_RP on a lattice; evolving the recognition-scale field C_RP from t=0 to t=t_click using a fractional d'Alembertian operator; performing spectral spatial processing on the recognition-scale field using an FFT-based path; performing fractional temporal integration on the recognition-scale field using a Grunwald-Letnikov or equivalent fractional-integration path; evaluating a non-linear cost function during evolution of the recognition-scale field; generating photon-temperature perturbation data from the evolved recognition-scale field; and outputting spherical-harmonic coefficients and an angular power spectrum, wherein the method is executed without fitting conventional cosmological parameters including H0, Omega_b, Omega_cdm, n_s, A_s, and tau.

2. The method of claim 1, wherein X_opt equals phi divided by pi, where phi is the golden ratio and pi is the circular constant.

3. The method of claim 1, further comprising comparing the angular power spectrum against a reference cosmic microwave background dataset by computing a sigma-scaled residual metric, and designating a run accepted when (i) an overall residual for multipoles 2-2500 is less than or equal to 1.0 and (ii) each band residual is less than or equal to 1.5 for bands {2-30, 30-800, 800-1500, 1500-2500}, and otherwise designating the run rejected and recording at least one failing band in an associated provenance record.

4. The method of claim 1, wherein the fractional d'Alembertian operator is of order five twelfths.

5. The method of claim 4, wherein the spectral spatial processing comprises transforming the recognition-scale field into a spectral-domain representation, multiplying the spectral-domain representation by a magnitude of a wavevector k raised to the five sixths power, and performing an inverse FFT to return an updated field to a spatial domain.

6. The method of claim 1, wherein the fractional temporal integration comprises applying a Grunwald-Letnikov fractional-integration approximation in which a current field value is computed using a weighted sum of stored prior time states spaced by a time step Delta t, and wherein a weight sequence includes an initial weight w0 equal to 1 and subsequent weights wj computed recursively from a prior weight w(j−1) using a factor that depends on the fractional order five sixths and an index j.

7. The method of claim 1, wherein the non-linear cost function is a function of X that includes a term proportional to one half of (X plus a reciprocal of X) minus 1, and is equivalent to a hyperbolic cosine of a logarithm of X minus 1.

8. The method of claim 1, wherein initializing the three-dimensional recognition-scale field comprises initializing the field around a cost minimum and introducing perturbations having an amplitude on the order of one times ten to the minus five.

9. The method of claim 1, wherein generating the photon-temperature perturbation data comprises applying a radiation-transfer stage that performs a line-of-sight integration of a source function S along a direction n_hat, and wherein outputting the spherical-harmonic coefficients and the angular power spectrum comprises generating spherical-harmonic coefficients a_lm from sky data and computing an angular power spectrum C_l from the spherical-harmonic coefficients.

10. A cosmogenesis simulation system comprising: an initial-grid synthesizer configured to generate an initialized recognition-scale field on a three-dimensional lattice; a spectral fractional-operator module configured to apply spectral spatial processing to the recognition-scale field; a temporal integration module configured to perform fractional temporal integration on the recognition-scale field; a non-linear cost core configured to evaluate a non-linear cost function during field evolution; a radiation-transfer module configured to generate photon-temperature perturbation data from an evolved recognition-scale field; a harmonic decomposition module configured to generate spherical-harmonic coefficients and an angular power spectrum; and one or more processors and or accelerators configured to execute the initial-grid synthesizer, the spectral fractional-operator module, the temporal integration module, the non-linear cost core, the radiation-transfer module, and the harmonic decomposition module, wherein the system is configured to perform parameter-free cosmic microwave background synthesis without fitting conventional cosmological parameters including ‘H0’, ‘Omega_b’, ‘Omega_cdm’, ‘n_s’, ‘A_s’, and ‘tau’.

11. The system of claim 10, wherein the one or more processors and or accelerators comprise a multi-GPU implementation.

12. The system of claim 11, wherein the multi-GPU implementation comprises four GPUs configured to cooperate in executing at least spectral processing and non-linear cost evaluation.

13. The system of claim 10, wherein the one or more processors and or accelerators comprise an FPGA implementation including a fixed-point cost core.

14. The system of claim 13, wherein the fixed-point cost core uses ‘24-bit fixed-point’ arithmetic.

15. The system of claim 13, wherein the fixed-point cost core uses a piecewise-polynomial approximation having ‘8’ segments.

16. A non-transitory computer-readable medium storing instructions that, when executed by one or more processors, cause the one or more processors to: define or receive a click time ‘t_click =X_opt/c’; initialize a three-dimensional recognition-scale field on a lattice; evolve the recognition-scale field from ‘t=0’ to ‘t=t_click’ using a fractional d'Alembertian operator; perform spectral spatial processing and fractional temporal integration on the recognition-scale field; evaluate a non-linear cost function during evolution of the recognition-scale field; generate photon-temperature perturbation data from an evolved recognition-scale field; and output spherical-harmonic coefficients and an angular power spectrum.

17. The non-transitory computer-readable medium of claim 16, wherein the instructions further cause the one or more processors to generate a sky map on a HEALPix grid.

18. The non-transitory computer-readable medium of claim 17, wherein the HEALPix grid has ‘N_side=2048’.

19. The non-transitory computer-readable medium of claim 16, wherein the instructions further cause the one or more processors to compare the angular power spectrum against a reference cosmic microwave background dataset by computing a sigma-scaled residual metric and to output, in a validation report, an accepted or rejected designation based on whether (i) an overall residual for multipoles 2-2500 is less than or equal to 1.0 and (ii) each band residual is less than or equal to 1.5 for bands {2-30, 30-800, 800-1500, 1500-2500}.

20. The non-transitory computer-readable medium of claim 16, wherein the instructions further cause the one or more processors to generate at least one output selected from a low-l metric report and a provenance bundle associated with a run of the method.
